(19) United States
(12) Patent Application Publication
(10) Pub. No.: US 2008/0008480 A1
(43) Pub. Date: Jan. 10, 2008

(54) Image forming apparatus

(75) Inventors: Norihide Momose, Kyoto (JP); Atsushi Kurimoto, Nara (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/822,439

(22) Filed: Jul. 5, 2007

(30) Foreign Application Priority Data
Jul. 7, 2006 (JP) 2006-188139
Nov. 1, 2006 (JP) 2006-297981

(51) Int. Cl. G03G 15/00

(52) U.S. Cl. 399/23

(57) ABSTRACT

In an image forming apparatus that uses an intermediate transfer system are provided a paper supply portion that stores a sheet of paper on which image forming is carried out, an image forming system that carries out image forming on the sheet of paper transported from the paper supply portion, and a detection portion that detects the number of sheets of paper stored in the paper supply portion, and image writing for carrying out image forming onto the sheet of paper is carried out in the image forming system before the sheet of paper stored in the paper supply portion is transported to the image forming system. In the image forming apparatus, upon detecting with the detection portion that the number of sheets of paper stored in the paper supply portion is not more than a preset number of sheets excluding zero sheets, an image writing sequence in the image forming system is changed in response to the detection in order to avoid development by developer. Furthermore, a plurality of image forming portions are provided in the image forming system and the image forming portion or portions to be used is selected depending on a specified printing mode, and the change in the image writing sequence is carried out depending on the printing mode.

### BACKGROUND OF THE INVENTION

This application claims priority under 35 U.S.C. § 119(a) on Patent Application No. 2006-188139 and Patent Application No. 2006-297981 filed in Japan respectively on Jul. 7, 2006 and Nov. 1, 2006, the entire contents of which are hereby incorporated by reference.

The present invention relates to image forming apparatuses that use an intermediate transfer system.

In recent years, the print processing speeds of image forming apparatuses have been becoming faster. Furthermore, in addition to conventional monochrome image forming apparatuses, development of color printing image forming apparatuses has been advancing. As an example of color printing image forming apparatuses there are image forming apparatuses (see JP 2006-84741A for example) that use an intermediate transfer system in which a color image is formed on a sheet of paper by using a plurality of electrostatic latent image carriers with color separated image information of a plurality of colors (for example, four colors of K, C, M, and Y) and overlaying and transferring these onto an intermediate transfer belt, which rotates and contacts the electrostatic latent image carriers with a predetermined pressure, after which en bloc transfer [of the images] is carried out onto a sheet of paper (recording sheet) that is transported in from a paper supply unit (a paper supply cassette for example).

When there is a request for printing in an intermediate transfer system image forming apparatus, a sheet of paper is transported from the paper supply cassette that is storing a sheet of paper of the specified size. In this regard, in a case where the sheets of paper stored in the paper supply cassette become used up midway during successive printing in the image forming apparatus, the print processing for the next sheet of paper has already started on the intermediate transfer belt when it is detected that the sheets of paper have been used up. This puts a burden on other components in that unfixed developer (toner) is wasted and the wasted developer adheres to other components (the cleaner unit, the photosensitive drum (electrostatic latent image carrier), the development device and the like).

Accordingly, in order to address these problems, an object of the present invention is to provide an image forming apparatus that uses an intermediate transfer system in which wasteful consumption of developer in the image forming system is prevented.

### SUMMARY OF THE INVENTION

In order to achieve the above-mentioned object, an image forming apparatus according to the present invention is provided with a paper supply portion that stores a sheet of paper on which image forming is carried out and an image forming system that carries out image forming on the sheet of paper transported from the paper supply portion, being an image forming apparatus that uses an intermediate transfer system in which image writing for carrying out image forming onto the sheet of paper is carried out in the image forming system before the sheet of paper stored in the paper supply portion is transported to the image forming system, wherein a detection portion is provided that detects the number of sheets of paper stored in the paper supply portion, as a result of the detection portion detecting that the number of sheets of paper stored in the paper supply portion is not more than a preset number of sheets excluding zero sheets, an image writing sequence in the image forming system is changed in response to the detection in order to avoid development by developer and in this configuration a plurality of image forming portions are provided in the image forming system and the image forming portion or portions to be used is/are selected depending on a specified printing mode, and the change in the image writing sequence is carried out depending on the printing mode.

With the present invention the detection portion is provided and an image writing sequence in the image forming system is changed in response to the detection in order to avoid development by developer by detecting with the detection portion that the number of sheets of paper stored in the paper supply portion is not more than a preset number of sheets excluding zero sheets, a plurality of image forming portions are provided in the image forming system and the image forming portion or portions to be used is selected depending on a specified printing mode, and the change in the image writing sequence is carried out depending on the printing mode, and therefore it is possible to prevent unnecessary consumption (image writing to no purpose) of developer (toner) in the image forming system of the image forming apparatus using the intermediate transfer system. As a result, it is possible to reduce the burden on other components of the image forming system (such as the cleaning units, the electrostatic latent image carriers, and the development units) and the life of the image forming apparatus can be increased. Specifically, when the print request number of sheets is for multiple sheets, the number of sheets of paper stored in the paper supply portion is detected and image writing exceeding the number of sheets of paper stored in the paper supply portion can be prevented. Furthermore, the paper detection target of the detection portion is the remaining number of sheets, and therefore compared to the detection unit that detects for no sheets (zero sheets), the transport time for transporting the sheet of paper from the paper supply portion to the image forming system can be shortened with respect to the time from the completion of the image writing process relating to an arbitrary color until the actual transfer (a part of image forming) of the image onto the sheet of paper. That is, the remaining number of sheets of paper can be used effectively, and therefore the transport time for transporting the sheet of paper from the paper supply portion to the image forming system can be shortened even in a case where the image writing for carrying out image forming onto the sheet of paper in the image forming system is carried out before the sheet of paper stored in the paper supply portion is transported to the image forming system, and as a result the transport distance of the sheet of paper from the paper supply portion to the image forming system can be shortened, such that it is possible to achieve miniaturization of the image forming apparatus. Furthermore, a plurality of image forming portions are provided in the image forming system and the image forming portion or portions to be used is selected depending on a specified printing mode, and image writing sequence changes are carried out depending on the printing mode, and therefore it is possible to selectively determine an optimal image forming portion based on the printing mode arbitrarily set by the user and an optimal image writing sequence can be executed. For this reason, it is possible to prevent unnecessary consumption (image writing to no purpose) of developer (toner) in the image forming system of the image forming apparatus using the intermediate transfer system.

In the above-described configuration, prior to detection of a change in an amount of paper remaining in the paper supply portion by the detection portion after the sheet of paper has been transported from the paper supply portion to the image forming system, an image writing sequence may start for the sheet of paper that has been transported.

In this case, prior to detection of a change in an amount of paper remaining in the paper supply portion by the detection portion after the sheet of paper has been transported from the paper supply portion to the image forming system, an image writing sequence starts for the sheet of paper that has been transported, and therefore it is possible to start the image writing sequence earlier than the transport start timing of the sheet of paper from the paper supply portion to the image forming system. As a result, the transport time for transporting the sheet of paper from the paper supply portion to the image forming system can be shortened.

In the above-described configuration, the change in the image writing sequence may involve changing an image writing operation in the image forming system from image writing in-process to image writing stoppage.

In this case, the change in the image writing sequence involves changing an image writing operation in the image forming system from image writing in-process to image writing stoppage, and therefore it is possible to reliably stop image writing.

In the above-described configuration, the preset number of sheets may refer to the number of sheets of paper stored being a near-end number of sheets.

In this case, the preset number of sheets refers to the number of sheets of paper stored being a near-end number of sheets, and therefore the sheet of paper for which image writing has already been carried out and requires image forming after the change in the image writing sequence can be secured, and as a result, it is possible to use all the sheets of paper stored in the paper supply portion at a time after there has been the change in the image writing sequence and image forming on the sheet of paper by the image forming system has finished. That is, it becomes possible to prevent unnecessary consumption (image writing to no purpose) of developer (toner) in the image forming system.

In the above-described configuration, the detection portion may use an ultrasonic sensor.

In this case, the detection portion uses an ultrasonic sensor and therefore when the remaining stored number of sheets of paper is a near-end number of sheets (from one sheet to several sheets), the number of sheets can be detected quickly and with excellent accuracy.

In the above-described configuration, the detection portion may be provided with a transmitter that transmits ultrasonic waves and a receiver that receives the ultrasonic waves transmitted from the transmitter, and the ultrasonic waves transmitted from the transmitter may be incident at an angle onto sheets of paper stored in the paper supply portion and received by the receiver through the sheets of paper.

In this case, the transmitter and the receiver are provided in the detection portion and the paper supply portion is arranged between the transmitter and the receiver, such that the ultrasonic waves transmitted from the transmitter are incident at an angle on the sheets of paper stored in the paper supply portion and received by the receiver through the sheets of paper, and therefore it is possible to prevent the ultrasonic waves that are incident on the sheets of paper from being reflected back onto the transmitter.

In the above-described configuration, the detection portion may have as a detection target a transport direction trailing edge portion of a sheet of paper stored in the paper supply portion.

In this case, the detection portion has as a detection target a transport direction trailing edge portion of a sheet of paper stored in the paper supply portion, and therefore it is possible to confirm at an earliest point that the sheet of paper has been transported (the number of sheets of paper has decreased) when transport of the sheets of paper stored in the paper supply portion has been carried out.

In the above-described configuration, the detection portion may have as a detection target at least a one side portion of a sheet of paper stored in the paper supply portion.

In this case, the detection portion has as a detection target at least a one side portion of a sheet of paper stored in the paper supply portion, and therefore the sheets of paper are stored having the width direction as a reference rather than a transport direction trailing edge side surface such that unevenness in the storage of the sheets of paper can be suppressed and paper transport errors originating in such storage unevenness can be prevented.

In the above-described configuration, the detection portion 41 may be a movable detection portion, and the detection portion may be arranged so as to readily move in and out with respect to a paper storage region in which a sheet of paper is stored in the paper supply portion.

In this case, since the detection portion is a movable detection portion and the detection portion is arranged so as to readily move in and out with respect to a paper storage region in which a sheet of paper is stored in the paper supply portion, this is preferable for improving the detection accuracy by reducing the distance between the sheets of paper and the detection portion.

In the above-described configuration, a movement of the detection portion toward the paper storage region may be carried out when the number of sheets of paper stored in the paper supply portion is not more than a preset number of sheets.

In this case, a movement of the detection portion toward the paper storage region is carried out when the number of sheets of paper stored in the paper supply portion is not more than a preset number of sheets. The detection portion is not positioned in the paper storage region when the number of sheets stored in the paper storage region is more than the preset number of sheets, therefore the detection portion can be kept from becoming an obstacle when paper is stored into the paper supply portion. The detection portion is positioned in the paper storage region when the number of sheets of paper stored in the paper supply portion becomes not more than the preset number of sheets and therefore only at a time of this condition is the distance between the sheets of paper and the detection portion reduced to enable improvements in detection accuracy.

In the above-described configuration, the detection portion may be provided with a detection lever portion that contacts an upper surface of a sheet of paper and a photo interrupter portion may be provided that detects an angle at which the detection lever portion tilts due to contact with the sheet of paper.

In this case, the detection portion is provided with the detection lever portion and the photo interrupter portion, and therefore when the number of sheets of paper stored in the paper supply portion becomes not more than the preset number of sheets so that the detection portion is arranged in the paper storage region, there is no contact of the detection portion to the sheets of paper while the detection portion moves in and out with respect to the paper storage region. Therefore, it is possible to suppress abrasions to the sheets of paper.

In the above-described configuration, when a time from an image writing sequence start until a formed development image reaches a transfer point to a sheet of paper is given as Tg, a time from an image writing sequence start until a next image writing sequence start is given as Tf, a time from start of supply of a sheet of paper from the paper supply portion until the sheet of paper reaching the transfer point is given as Tc, and a time from start of supply (transport) of a sheet of paper from the paper supply portion until detection of a change in an amount of paper remaining by the detection portion is given as Te, a relationship of (Tc−Te)<(Tg−Tf) may be satisfied with respect to a detection target of the detection portion.

In this case, a relationship of (Tc−Te)<(Tg−Tf) is satisfied with respect to a detection target of the detection portion, and therefore it is possible to shorten the transport time for transporting the sheets of paper from the paper supply portion to the image forming system.

In the above-described configuration, a plurality of paper supply cassettes may be included in the paper supply portion, respective transport times of a sheet of paper transported from the paper supply cassettes to the image forming system may be set separately for the plurality of paper supply cassettes, and an ultrasonic sensor may be used in the detection portion whose detection target is the paper supply portion satisfying the relationship of (Tc−Te)<(Tg−Tf).

In this case, a plurality of paper supply cassettes are included in the paper supply portion, respective transport times of a sheet of paper transported from the paper supply cassettes to the image forming system are set separately for the plurality of paper supply cassettes, and an ultrasonic sensor is used in the detection portion whose detection target is the paper supply portion satisfying the relationship of (Tc−Te)<(Tg−Tf), and therefore it is possible to carry out paper detection corresponding to all the paper supply cassettes.

In the above-described configuration, the printing modes may be constituted by an n color printing mode and an m color printing mode having more colors than n colors, when the printing mode is the m color printing mode, the change in the image writing sequence may involve changing an image writing operation in the image forming system from image writing in-process to image writing stoppage, and when the printing mode is the n color printing mode, the change in the image writing sequence may involve changing the image writing operation in the image forming system to the image writing stoppage after image writing of a preset number of sheets excluding zero sheets detected by the detection portion has been carried out.

In the above-described configuration, the printing modes may also be constituted by a color printing mode and a monochrome color printing mode, when the printing mode is the color printing mode, the change in the image writing sequence may involve changing the image writing operation in the image forming system from the image writing in-process to the image writing stoppage, and when the printing mode is the monochrome color printing mode, the change in the image writing sequence may involve changing the image writing operation in the image forming system to the image writing stoppage after image writing of the preset number of sheets excluding zero sheets detected by the detection portion has been carried out.

Furthermore, the intermediate transfer system may be a system in which image writing is carried out in a plurality of image forming portions respectively, and respective images from the plurality of image forming portions are layered and transferred in a preset order, and then transferred en bloc to a sheet of paper, may be constituted by a late printing mode using, of the plurality of image forming portions, an image forming portion that performs layer in an order later than a preset layer order including non-transfer image forming portions that do not perform transfer due to not being used in image forming onto the sheet of paper, and an early printing mode using, of the plurality of image forming portions, an image forming portion that performs layer in an order earlier than the preset layer order including non-transfer image forming portions that do not perform transfer due to not being used in image forming onto the sheet of paper, such that when the printing mode is the early printing mode, the change in the image writing sequence may involve changing an image writing operation in the image forming system from image writing in-process to image writing stoppage, and when the printing mode is the late printing mode, the change in the image writing sequence involves changing the image writing operation in the image forming system to the image writing stoppage after image writing of the preset number of sheets excluding zero sheets detected by the detection portion has been carried out.

### BRIEF DESCRIPTION OF THE DRAWINGS

FIG. 1 is an outline configuration drawing showing an image forming system and a paper transport system of an image forming apparatus using an intermediate transfer system according to working example 1.

FIG. 2A is an outline configuration drawing showing a paper supply cassette that stores multiple sheets of paper and a detection portion according to working example 1. FIG. 2B is an outline configuration drawing showing the paper supply cassette in a paper near-end condition and the detection portion according to working example 1.

FIG. 3 is an outline block diagram showing a portion of a control system according to working example 1.

FIG. 4 is an explanatory diagram schematically showing a positional relationship between an image forming system and the paper transport system according to working example 1.

FIG. 5 is a timing chart that shows a relationship between an image writing signal relating to yellow, an image transfer signal in a secondary transfer portion, a paper pickup signal of a pickup roller, and a detection signal of no sheets being detected by the detection portion according to working example 1.

FIG. 6 is a timing chart that shows a relationship between an image writing signal relating to yellow, an image transfer signal in the secondary transfer portion, a paper pickup signal of a pickup roller, and a detection signal of no sheets being detected by the detection portion in an image forming apparatus that uses a detection portion that detects for there being no sheets.

FIG. 7 is an outline configuration drawing of a detection portion according to another example of working example 1.

FIG. 8A is an outline configuration drawing showing a paper supply cassette that stores multiple sheets of paper and a detection portion according to another example of working example 1. FIG. 8B is an outline configuration drawing showing a paper supply cassette in a paper near-end condition and a detection portion according to another example of working example 1.

FIG. 9A is an outline configuration drawing showing a paper supply cassette that stores multiple sheets of paper and a detection portion according to another example of working example 1. FIG. 9B is an outline configuration drawing showing a paper supply cassette in a paper near-end condition and a detection portion according to another example of working example 1.

FIG. 10A is an outline configuration perspective view of a detection portion according to still another example of working example 1. FIG. 10B is an outline configuration front view of a detection portion according to still another example of working example 1.

FIG. 11 is an outline configuration drawing showing an image forming system and a paper transport system of an image forming apparatus using an intermediate transfer system according to working example 2.

FIG. 12 is an explanatory diagram schematically showing a positional relationship between an image forming system and the paper transport system according to working example 2.

FIG. 13 is a graph showing detection output for different numbers of sheets of paper by the detection portion according to working example 2.

FIG. 14 is a flowchart relating to image forming in color printing mode/monochrome printing mode according to working example 3.

FIG. 15 is a timing chart relating to image forming in color printing mode according to working example 3.

FIG. 16 is a timing chart relating to image forming in monochrome printing mode according to working example 3.

FIG. 17 is a flowchart relating to image forming in an early printing mode/late printing mode according to working example 4.

FIG. 18 is a timing chart relating to image forming in the early printing mode according to working example 4.

FIG. 19 is a timing chart relating to image forming in the late printing mode according to working example 4.

### DESCRIPTION OF THE PREFERRED EMBODIMENTS

Hereinafter, embodiments of the present invention are described with reference to the accompanying drawings. It should be noted that the following working examples indicate a case in which the present invention is applied to a multifunction machine as an image forming apparatus provided with a combination of a copying function, a printing function, and a facsimile function, but there is no limitation to this.

### WORKING EXAMPLE 1

### —Description of Overall Configuration of Image Forming Apparatus—

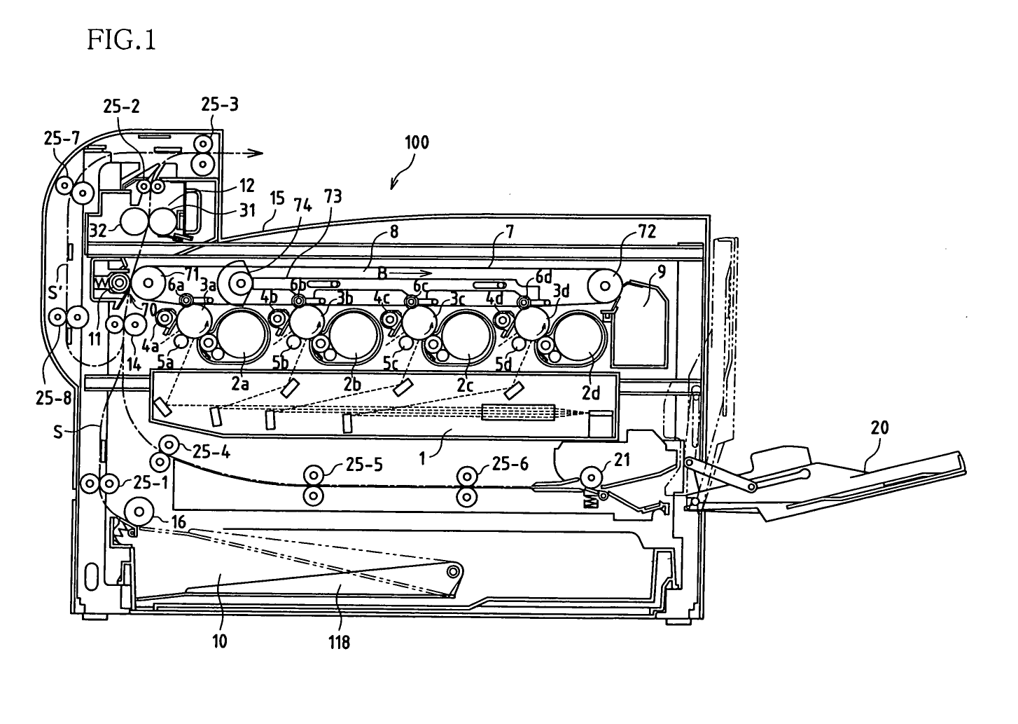

As shown in FIG. 1, an image forming apparatus 100 according to working example 1 is provided with an image reading system (omitted from drawing), an image forming system, a paper transport system, and a control system. The following is a description of the components therein.

—Description of Image Reading System—

An image reading system of the image forming apparatus 100 according to working example 1 includes a scanner portion (omitted from drawing) arranged in an upper part of the image forming apparatus. The scanner portion reads images such as an image of a manuscript placed on a document table (omitted from drawing) made of a material such as transparent glass and images of manuscripts supplied sheet by sheet by an unshown automatic paper supply portion (omitted from drawing), and generates manuscript image data.

—Description of Image Forming System—

As shown in FIG. 1, an image forming system of the image forming apparatus 100 according to working example 1 is constituted by components including an exposing unit 1, development units 2 (2a, 2b, 2c, and 2d), photosensitive drums (electrostatic latent image carriers) 3 (3a, 3b, 3c, and 3d), cleaner units 4 (4a, 4b, 4c, and 4d), main charging units 5 (5a, 5b, 5c, and 5d), an intermediate transfer belt unit 8, and a fixing unit 12. According to image data transmitted from an external portion, the image forming apparatus 100 forms a multicolor (color) or a single color (monochrome) image on a predetermined sheet of paper P (recording sheet).

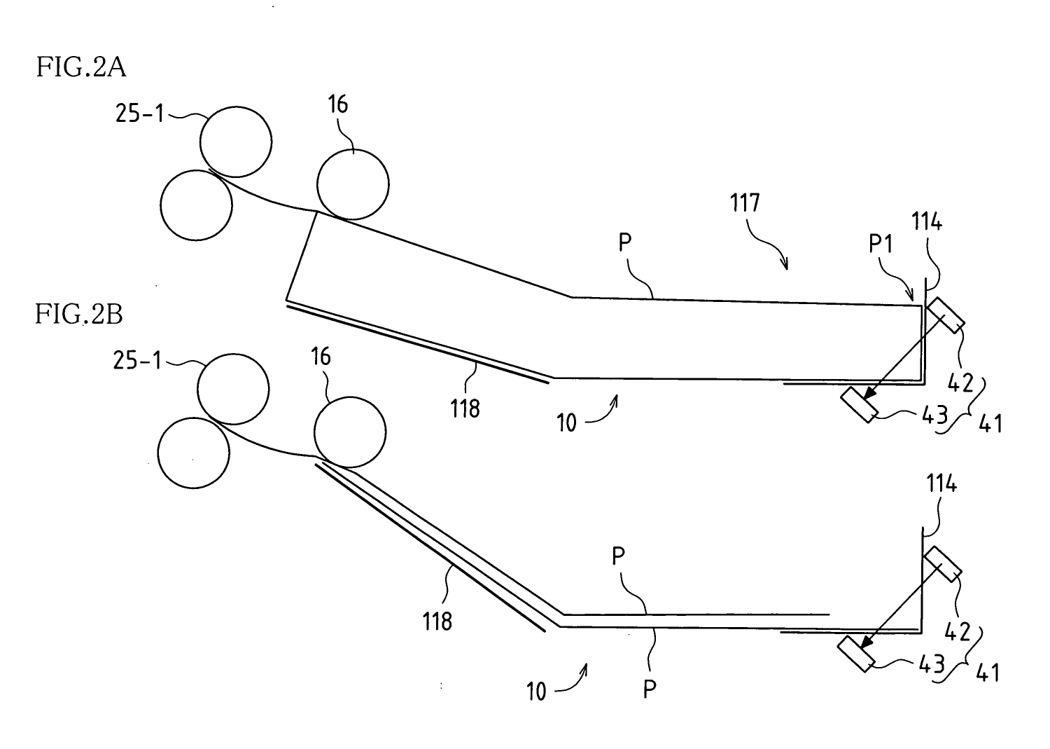

Then, as is described later, the image forming apparatus 100 is configured as a color image forming apparatus that uses an intermediate transfer system in which, after color separated image information of a plurality of colors (four colors in this example) undergoes layered transfer onto an intermediate transfer belt 7 (see below) that contacts and rotates with a predetermined pressure against a plurality (four in this example) of photosensitive drums 3, a color image is formed on a sheet of paper P by transferring the layered image information en bloc onto the sheet of paper P (see FIG. 2A, FIG. 2B, and FIG. 4) transported from a later described paper supply cassette 10 or a manual loading tray 20.

It should be noted that image data handled in the image forming apparatus 100 corresponds to color images using the colors black (K), cyan (C), magenta (M), and yellow (Y). Accordingly, four each of the development units 3 (2a, 2b, 2c, and 2d), photosensitive drums 3 (3a, 3b, 3c, and 3d), cleaner units 4 (4a, 4b, 4c, and 4d) and main charging units 5 (5a, 5b, 5c, and 5d), are provided corresponding to the four colors (K, C, M, and Y) respectively to form four latent images, and these are configured in four image stations (image forming portions) in the image forming apparatus 100. It should be noted here that structural members having a suffix “a” correspond to black, structural members having a suffix “b” correspond to cyan, structural members having a suffix “c” correspond to magenta, and structural members having a suffix “d” correspond to yellow. Furthermore, as shown in FIG. 1, of the four image stations, the image station relating to yellow is the image station arranged in a position farthest from a transport path S (see below).

The photosensitive drums 3 are arranged (mounted) at an upper part of the image forming apparatus 100. Components such as the development units 2 (2a, 2b, 2c, and 2d), the cleaner units 4 (4a, 4b, 4c, and 4d), and the main charging units 5 (5a, 5b, 5c, and 5d) are arranged around their respective photosensitive drums 3 (3a, 3b, 3c, and 3d).

The main charging units 5 are for uniformly charging the surface of the photosensitive drums 3 to a predetermined electric potential and in this example, contact method roller type charging units are used. It should be noted that brush type charging units and charge type charging units may also be used.

The exposing unit 1 exposes the photosensitive drums 3, which have been charged by the main charging units 5, according to inputted image data and form electrostatic latent images on the surfaces thereof that correspond to the image data, and in this example a laser scanning unit (LSU), which is provided with a laser irradiation portion and a reflector mirror, is used. It should be noted that an EL or LED writing head or the like in which light-emitting elements are arranged in an array may also be used.

The development units 2 form toner images of each color by using developer (toner) of each color (K, C, M, and Y) to manifest the electrostatic latent images that have been formed on the respective photosensitive drums 3, and the toner images formed on the photosensitive drums 3 by the development units 2 are transferred (primary transfer) to the intermediate transfer belt 7.

The cleaner units 4 remove and collect toner that is residual on the surfaces of the photosensitive drums 3 after development and transfer.

The intermediate transfer belt unit 8 positioned above the photosensitive drums 3 is for forming a color image on the sheet of paper P using the intermediate transfer system, and is provided with intermediate transfer rollers 6 (6a, 6b, 6c, and 6d), an intermediate transfer belt 7, an intermediate transfer belt drive roller 71, an intermediate transfer belt idler roller 72, an intermediate transfer belt tension mechanism 73, and an intermediate transfer belt cleaning unit 9. It should be noted that the suffixes a, b, c, and d for the intermediate transfer rollers 6 correspond to the suffixes for the above-described image stations.

The intermediate transfer belt 7 spans in a tension state around components such as the intermediate transfer belt drive roller 71, an intermediate transfer belt tension roller 74 of the intermediate transfer belt tension mechanism 73, the intermediate transfer rollers 6, and the intermediate transfer belt idler roller 72, and is rotationally driven in a direction of arrow B. In this example, the intermediate transfer belt 7 is formed as an endless shape using a film of a thickness in a range of 100 μm to 150 μm. Furthermore, the intermediate transfer belt 7 is provided so as to be sandwiched by the photosensitive drums 3 and the intermediate transfer rollers 6 respectively. The toner images that are formed on the photosensitive drums 3 respectively are layered and transferred successively onto the intermediate transfer belt 7 to form a color toner image (multicolor toner image) on the intermediate transfer belt 7.

The transfer of the toner images from the photosensitive drums 3 to the intermediate transfer belt 7 is carried out using the intermediate transfer rollers 6 that are rotatably supported on intermediate transfer roller mounting portions of the intermediate transfer belt tension mechanism 73. Specifically, the intermediate transfer rollers 6 are in contact with a back side of the intermediate transfer belt 7 and a high voltage transfer bias (a (+) high voltage that has inverse polarity to the (−) charge polarity of the toner) is applied to the intermediate transfer rollers 6 to achieve transfer of the toner images on the photosensitive drums 3 to the intermediate transfer belt 7. Then, transfer of the toner images from the photosensitive drums 3 to the intermediate transfer belt 7 is carried out by applying the high voltage transfer bias to the intermediate transfer rollers 6 while the intermediate transfer rollers 6 and the photosensitive drums 3 are in contact through the intermediate transfer belt 7.

The intermediate transfer rollers 6 are rollers based on a metal shaft (for example stainless steel or the like) with a diameter of 8 to 10 mm and the surface thereof is covered by a conductive elastic material (for example, EPDM and foam urethane or the like). With this conductive elastic material, it is possible to apply a uniform high voltage to the intermediate transfer belt 7. It should be noted that in this example roller type transfer electrodes are used, but brush type components may also be used.

As described above, inputted image information is manifested in the respective colors on the photosensitive drums 3, then layered and transferred onto the intermediate transfer belt 7. Then, due to rotation of the intermediate transfer belt 7, the layered image information is transferred (secondary transfer) en bloc onto the sheet of paper P in a secondary transfer portion 70 in which the intermediate transfer belt 7 and a secondary transfer roller 11 are in pressure contact.

At this time, the intermediate transfer belt 7 and the secondary transfer roller 11 are pressed against each other at a predetermined nip in the secondary transfer portion 70 and a voltage (a (+) high voltage that has inverse polarity to the (−) charge polarity of the toner) is applied to the secondary transfer roller 11 in order for the multicolor toner image that has been layered onto the intermediate transfer belt 7 to be transferred to the sheet of paper P. Then, by having one of the secondary transfer roller 11 and the intermediate transfer belt drive roller 71 set as a roller of a hard material (for example a metal or the like) and the other set as an elastic roller of a flexible material (for example rubber, foam resin or the like), the above-mentioned nip is maintained steadily.

Of the toner that has adhered to the intermediate transfer belt 7 due to contact with the respective photosensitive drums 3, the residual toner on the intermediate transfer belt 7 not transferred to the sheet of paper P by the secondary transfer roller 11 is a cause of toner of mixed colors in subsequent processes, and is therefore removed and recovered by the intermediate transfer belt cleaning unit 9. The intermediate transfer belt cleaning unit 9 is provided with a cleaning blade for example as a cleaning member that makes contact with the intermediate transfer belt 7. The intermediate transfer belt 7 is supported from a rear side by the intermediate transfer belt idler roller 72 at a position in contact with the cleaning blade.

The fixing unit 12 is provided with a heat roller 31 and a pressure roller 32, etc., and the heat roller 31 and the pressure roller 32 are configured so as to rotate with the sheet of paper P being sandwiched therebetween. The heat roller 31 is subjected to temperature control based on signals from a temperature detector (omitted from drawing) so as to be at a predetermined fixing temperature. The heat roller 31 and the pressure roller 32 melt, mix, and press against the multicolor toner image that has been transferred to the sheet of paper P by performing thermo compression on the sheet of paper P. In this way, the multicolor toner image is thermally fixed onto the sheet of paper P. After the fixing by the fixing unit 12, the sheet of paper P is transported by transport rollers (25-2 and 25-3), then discharged face down (the multicolor toner image facing downward) into a discharge tray 15 (see below).

—Description of Paper Transport System—

A paper transport system of the image forming apparatus 100 according to the present embodiment is constituted by a paper supply portion in which the sheets of paper P to be used in image forming are accumulated and stored, a paper discharge portion for discharging sheets of paper (printed sheets of paper) on which images have been formed by the image forming system on sheets of paper stored in the paper supply portion, and a transport path S on which the sheets of paper stored in the paper supply portion are transported to the paper discharge portion.

As shown in FIGS. 1 and 2, the paper supply portion involves a paper supply cassette 10 that is provided at an under side of the image forming system of the image forming apparatus 100. It should be noted that working example 1 is provided not only with the paper supply cassette 10, but a manual loading tray 20 into which sheets of paper are directly supplied from outside.

As shown in FIGS. 1 and 2, the paper discharge portion involves the discharge tray 15 that is provided at an upper side of the image forming system of the image forming apparatus 100 and that is for placing face down sheets of paper that have been printed.

Furthermore, the paper transport path S is provided that transports sheets of paper from the paper supply cassette 10 to the discharge tray 15 via the image forming system (the secondary transfer portion 70 and the fixing unit 12). Arranged in the vicinity of the paper transport path S from the paper supply cassette 10 to the discharge tray 15 are a pickup roller (paper transport roller) 16, a register roller 14, the secondary transfer portion 70, the fixing unit 12, and transport rollers 25 that transport the sheets of paper and the like. And the paper transport path S is formed substantially vertically such that the sheets of paper P are transported in a substantially vertical direction between from transport rollers 25-1 arranged near the paper supply cassette 10 to transport rollers 25-3 arranged near the discharge tray 15.

The transport rollers 25 are small-size rollers for facilitating and assisting the transport of the sheets of paper and a plurality of these are provided along the paper transport path S. The pickup roller 16 is provided at a leading end portion of the paper supply cassette 10 and is a pull-in roller that supplies sheets of paper P one by one from the paper supply cassette 10 to the paper transport path S. Furthermore, the registration rollers 14 are rollers that temporarily hold the sheets of paper P that have been transported along the paper transport path S and that transport the sheets of paper P to the secondary transfer portion 70 with a timing that matches the leading edge of the sheet of paper P and the leading edge of the multicolor toner image on the intermediate transfer belt 7.

In the paper transport path S, a sheet of paper P supplied from the paper supply cassette 10 is transported to the registration rollers 14 by the transport rollers 25-1, then transported to the secondary transfer portion 70 with a timing in which the leading edge of the sheet of paper P and the leading edge of the image information on the intermediate transfer belt 7 are matching such that the image information is written onto the sheet of paper P by the secondary transfer portion 70. After this, unfixed toner on the sheet of paper P is fused and fixedly attached by the fixing unit 12, then the sheet of paper P is transported by transport rollers 25-2 and the transport rollers (discharge rollers) 25-3, then discharged face down (the multicolor toner image facing downward) into the discharge tray 15 (in the case of a request for single sided printing).

On the other hand, in the case of a request for double sided printing, after single sided printing is completed as described above the trailing edge of the sheet of paper P that has passed through the fixing unit 12 is chucked by the discharge rollers 25-3 and guided to an inverse transport path S′ by reverse rotation of the paper discharge rollers 25-3. In the inverse transport path S′, the sheet of paper P is transported by transport rollers 25-7 and 25-8, then guided again on the paper transport path S. Reverse side printing is then carried out via the registration rollers 14 after which the sheet is discharged to the discharge tray 15.

Arranged in the image forming apparatus 100 are the paper supply cassette 10 and the manual loading tray 20 so that opening and closing operations of the paper supply cassette 10 are not required when the user carries out printing of small number of sheets. A pickup roller 21 is provided at an end portion of the manual loading tray 20 and is configured to guide the sheets of paper in the manual loading tray 20 sheet by sheet onto the paper transport path S. The sheets of paper P loaded in the manual loading tray 20 are supplied by the pickup roller 21 and transported to the registration rollers 14 via a plurality of transport rollers (25-6, 25-5, and 25-4). Thereafter, the sheets of paper P are discharged to the discharge tray 15 in a same manner as in the case of the sheets of paper P carried from the paper supply cassette 10.

Next, FIGS. 1 and 2 are used to give description of a paper supply method in the image forming apparatus 100.

First, detailed description is given of the paper supply cassette 10 using FIGS. 1 and 2. As stated earlier, the pickup roller 16 is arranged at the leading edge portion of the paper supply cassette 10. The sheets of paper stored in the paper supply cassette 10 are supplied to the paper transport path S sheet by sheet by an operation of the pickup roller 16.

A paper leading edge pressing plate (omitted from drawings) and a paper trailing edge pressing plate 114 are provided at the leading edge portion and trailing portion of the paper supply cassette 10 and are configured to store the sheets of paper P in a state in which the leading edges and the trailing edges of the sheets of paper P are being pressed. In contrast to the paper leading edge pressing plate, which is fixed at the leading edge portion of the paper supply cassette 10, the paper trailing edge pressing plate 114 is attached to a sliding plate (omitted from drawings) that slides back and forth along a groove formed in bottom surface of the paper supply cassette 10. The sliding plate enables the paper trailing edge pressing plate 114 to slide to a position corresponding to the size of the sheets of paper P being stored such that the leading edges of the sheets of paper P are always aligned to a predetermined position. Furthermore, a rotating plate 118 is provided and this is configured to raise upward the leading edge side of the sheets of paper P stored in the paper supply cassette 10.

Furthermore, a detection portion 41, which detects the number of the sheets of paper P stored in the paper supply cassette 10, is provided in the above-described paper transport system. In more detail, the detection portion 41 is a component that detects whether or not the number of the sheets of paper P stored in the paper supply cassette 10 is not more than a preset number of sheets but excluding zero sheets. Here, “preset number of sheets” refers to a near-end number of sheets for the sheets of paper P being stored (which is from one sheet to several sheets and is set to one sheet in the present working example 1). The detection portion 41 in this example is a double-feeding sensor that uses ultrasonic waves and, as shown in FIGS. 2 an 4, is provided with at least a transmitter 42 that transmits ultrasonic waves and a receiver 43 that receives the ultrasonic waves transmitted by the transmitter 42. With the detection portion 41, the number of sheets of paper being stored is determined based on an amount of attenuation of signals of the ultrasonic waves that are transmitted by the transmitter 42 and received by the receiver 43.

As shown in FIG. 2, a positional relationship between the detection portion 41 and the paper supply cassette 10 is such that the paper supply cassette 10 is arranged between the transmitter 42 and the receiver 43. Furthermore, the detection portion 41 has as a target for detection a transport direction trailing edge portion P1 of the sheets of paper P stored in the paper supply cassette 10 and the detection portion 41 is provided in the paper trailing edge pressing plate 114, which is arranged near the transport direction trailing edge portion P1 of the sheets of paper P stored in the paper supply cassette 10. Specifically, as shown in FIG. 2, the transmitter 42 is provided in a part of the paper trailing edge pressing plate 114 at a corner area of the transport direction trailing edge portion P1 of the sheets of paper P stored in the paper supply cassette 10, and the receiver 43 is provided in a part of the paper trailing edge pressing plate 114 at an underneath side corner area of the sheets of paper P stored in the paper supply cassette 10 such that ultrasonic waves sent from the transmitter 42 are incident at an angle on the sheets of paper P stored in the paper supply cassette 10 and are received by the receiver 43 through the sheets of paper P.

Upon detecting with the diction portion 41 that the number of the sheets of paper P stored in the paper supply cassette 10 is one sheet or less, an image writing sequence of the image forming system is changed to avoid development by toner on the photosensitive drums 3 in response to the detection by the detection portion 41. In the present working example, an image writing operation of the image forming system is changed from image writing in-process to image writing stoppage. This configuration of the detection portion 41 is useful in the image forming apparatus indicated in the present working example 1, in which the number of sheets requested for image forming onto the sheets of paper P (print request number of sheets) is a multiple number of sheets and image writing for carrying out image forming onto the sheets of paper P is carried out before the sheets of paper P stored in the paper supply cassette 10 are transported to the image forming system. In the image forming apparatus 100, prior to detection by the detection portion 41 of a change in the amount of paper remaining in the paper supply cassette 10 (such as the remaining number of sheets changing from two sheets to one sheet) after a sheet of paper P has been transported from the paper supply cassette 10 to the image forming system, the image writing sequence for the thus-transported sheet of paper P starts.

—Description of Control System—

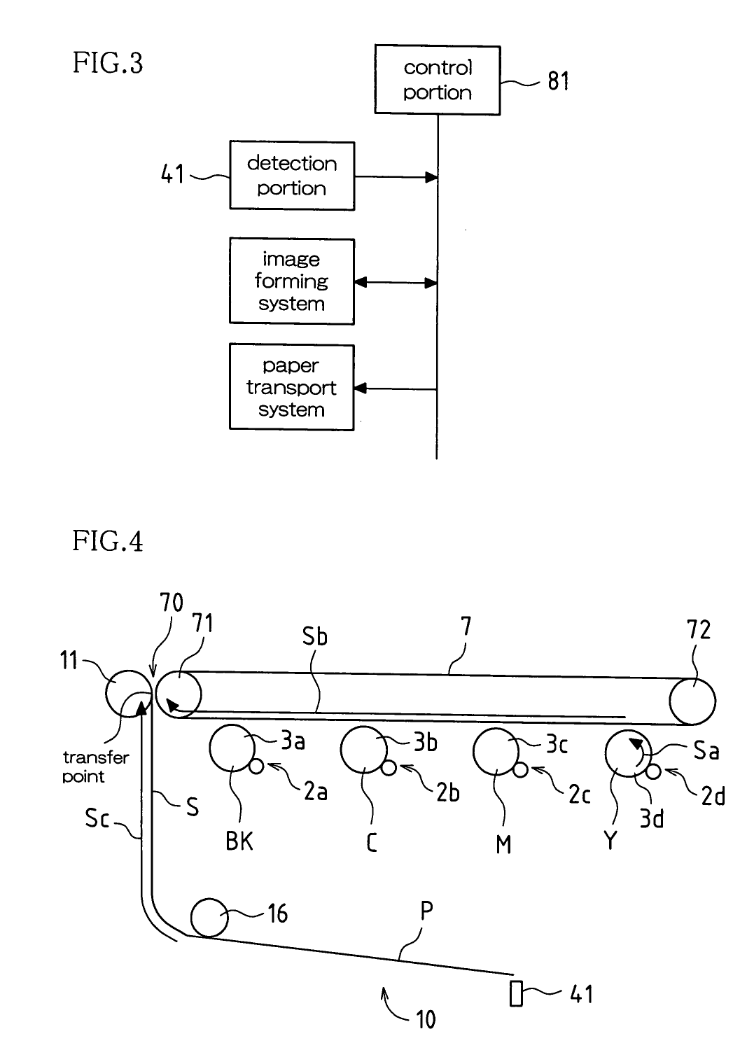

As shown in FIG. 3, the control system of the image forming apparatus 100 according to working example 1 is configured including a control portion 81 or the like for performing integrated control of the entire apparatus. It should be noted that FIG. 3 shows a portion of the control system. The control portion 81 performs management using sequence control of the drive mechanism portions that constitute the image forming apparatus 100 such as the image reading system, the image forming system, and the paper transport system (omitted from drawing), and outputs control signals to each system (each member) based on detection values of the detection portion 41.

Next, description is given regarding a timing by which paper supply is carried out in the image forming apparatus 100.

In the image forming apparatus 100, when there is print request for multiple sheets (when there is a request for successive printing), first, print pre-processing is carried out. After the print pre-processing, print processing and paper supply process are carried out for the first sheet of paper.

Print processing is constituted by print processing of the first color to the fourth color (which is the image writing referred to in the present invention) and en bloc transfer processing, and en bloc transfer processing is carried out after the print processing of the first color to the fourth color. The print processing of the first color to the fourth color is carried out in order from the image station arranged farthest from the secondary transfer portion 70, which is carried out in an order beginning from print processing of the first color (which in this example is yellow), then print processing of the second color (which in this example is magenta), print processing of the third color (which in this example is cyan), and print processing of the fourth color (which in this example is black). The print processing of each of the colors is constituted by a main charging process of charging the photosensitive drums 3 using the main charging units 5, an image exposing process of exposing the photosensitive drums 3 using the exposing unit 1 to form electrostatic latent images on the surfaces thereof, a development process of manifesting the electrostatic latent images using toner of the development units 2 to form toner images on the photosensitive drums 3, and a transfer process of transferring the toner images to the intermediate transfer belt 7, and these processes are carried out in an order of main charging process, image exposing process, development process, and transfer process.

The main charging process of the first color print processing in the print processing for the first sheet of paper is carried out after print pre-processing. In the print processing of the first color to the fourth color, a toner image of each of the colors is layered and transferred successively onto the intermediate transfer belt 7, and in this way a color toner image (multicolor toner image) is formed on the intermediate transfer belt 7. In the en bloc transfer processing, the multicolor toner image on the intermediate transfer belt 7 is transferred en bloc to the sheet of paper P that is transported into the secondary transfer portion 70.

The main charging process within the print processing of the first color in the print processing for the second sheet of paper P starts with a timing midway in the print processing of the second color in the print processing for the first sheet of paper P. The print processing for the second sheet of paper P and onward is carried out in the same order as the print processing for the first sheet of paper. Then, print processing for the third sheet of paper P and onward is carried out with the same timing.

On the other hand, when the print request number of sheets is for multiple sheets, in the paper pickup process in the paper supper process, in which the sheets of paper P stored in the paper supply cassette 10 are supplied to the paper transport path S sheet by sheet by the pickup roller 16, the timing by which the pickup of the second sheet of paper P onward finishes is set to be prior to the start of the main charging process of the print processing of the first color in the print processing for the subsequent sheet of paper P. The “subsequent sheet of paper P” refers to the next sheet with respect to the sheet of paper P undergoing paper supply process.

Then, by carrying out the paper supply process and the print processing of the sheets of paper P for the print request for multiple sheets as described above, multiple printed sheets of paper P are discharged to the discharge tray 15 and the number of sheets of paper P stored in the paper supply cassette 10 continues to decrease. At this time, at the paper supply cassette 10 as shown in FIGS. 2, 4, and 5, detection is conducted by the detection portion 41 as to whether or not the number of sheets of paper stored in the paper supply cassette 10 is one sheet or less, and when the number of stored sheets of paper decreases to one sheet remaining, it is detected by the detection portion 41 that the number of sheets of paper stored in the paper supply cassette 10 is one sheet or less, and based on this detection, the image writing operation in the image forming system changes from image writing in-process to image writing stoppage.

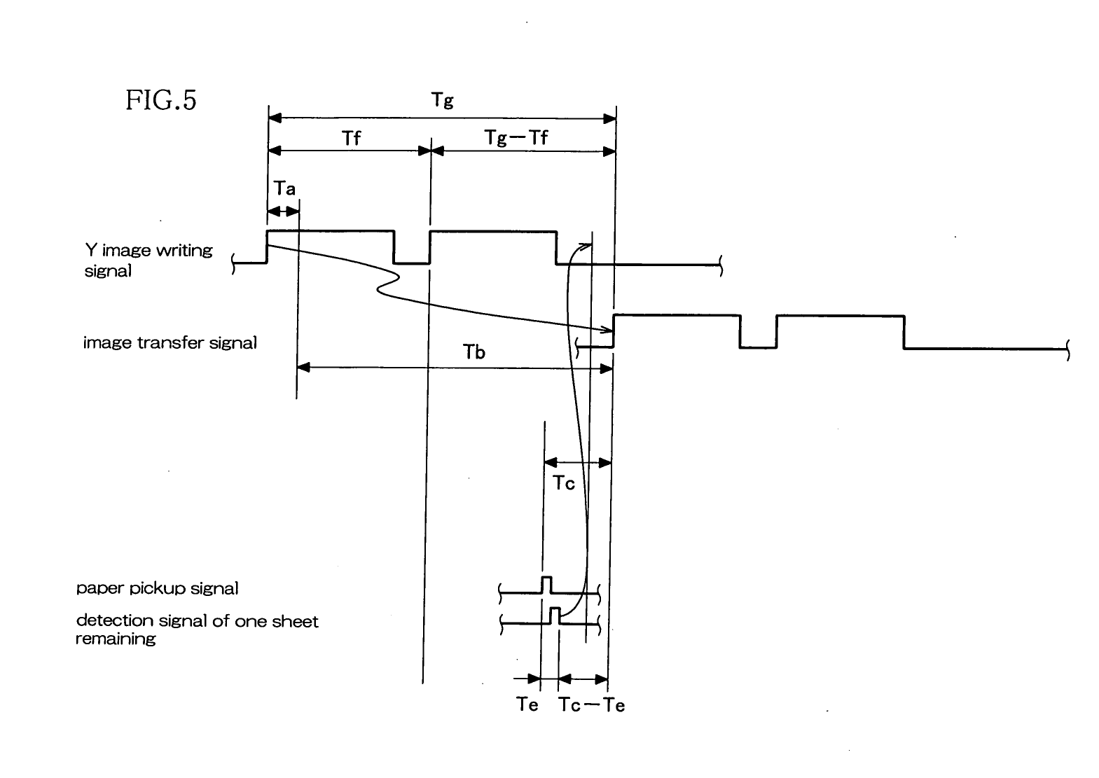

It should be noted that FIG. 5 is a timing chart that shows a relationship between an image writing signal relating to yellow (Y), an image transfer signal in the secondary transfer portion 70, a paper pickup signal of the pickup roller 16, and a detection signal of one sheet remaining being detected by the detection portion 41. A symbol Ta shown in FIG. 5 indicates a time required for the writing process relating to yellow (first color print processing) and corresponds to a movement distance Sa shown in FIG. 4 on a surface position of the photosensitive drum 3d, obtained by a writing position of the laser by the exposing unit 1 of the photosensitive drum 3d, which has been charged in the main charging process, moving through rotation to a position of transfer to the intermediate transfer belt 7 in the transfer process. Furthermore, a symbol Tb shown in FIG. 5 indicates a time required from the yellow toner on the photosensitive drum 3d undergoing primary transfer to the intermediate transfer belt 7 until being transferred on the sheet of paper P by the secondary transfer roller 11, and corresponds to a distance Sb shown in FIG. 4 in which the transfer position of the intermediate transfer belt 7 on which toner relating to yellow has been transferred moves until the secondary transfer roller 11. Furthermore, a symbol Tc shown in FIG. 5 indicates a transport time from pickup of the sheet of paper P by the pickup roller 16 in the paper supply cassette 10 until a transfer point (secondary transfer roller 11) of the sheet of paper P that has been picked up, and corresponds to a distance Sc of the transport path S shown in FIG. 4 of the sheet of paper from the pickup roller 16 until the secondary transfer roller 11. Furthermore, a symbol Tg shown FIG. 5 indicates a time from an image writing sequence start (writing process start relating to yellow) until the toner that has been formed (the toner adhering to the secondary transfer roller 11) reaches the secondary transfer roller 11 (transfer point), and corresponds to a time (Ta+Th) of an addition of the above-described time Ta and the time Th. Furthermore, a symbol Tf shown in FIG. 5 indicates a time from an image writing sequence start (for example, the writing process start relating to yellow for the first sheet of paper P) until the next image writing sequence start (for example, the writing process start relating to yellow for the second sheet of paper P). Furthermore, a symbol Te shown in FIG. 5 indicates a time from supply start (transport) of the sheet of paper P from the paper supply cassette 10 until detection of a change in amount of paper remaining by the detection portion 41. And in the image forming apparatus 100 of the present working example 1, a detection target of the detection portion 41 is set so as to satisfy a relationship of (Tc−Te)<(Tg−Tf) being satisfied.

Regarding a change to the above-described image writing sequence, specifically, as shown in FIGS. 4 and 5, when the remaining stored number of sheets of paper P is detected by the detection portion 41 as one sheet after the sheet of paper P has been picked up by the pickup roller 16, the output of the image writing signal relating to yellow stops. Furthermore, the same operation is also carried out with regard to the other colors (magenta, cyan, and black).

Incidentally, a case where the image forming apparatus uses a detection portion that detects there being no paper (zero sheets) without using the detection portion 41 of working example 1, which is different from working example 1, is as follows. It should be noted that in order to compare detection states of the remaining stored number of sheets of paper P being one sheet and empty (zero sheets) here, for convenience the same configuration as working example 1 is used with regard to other components.

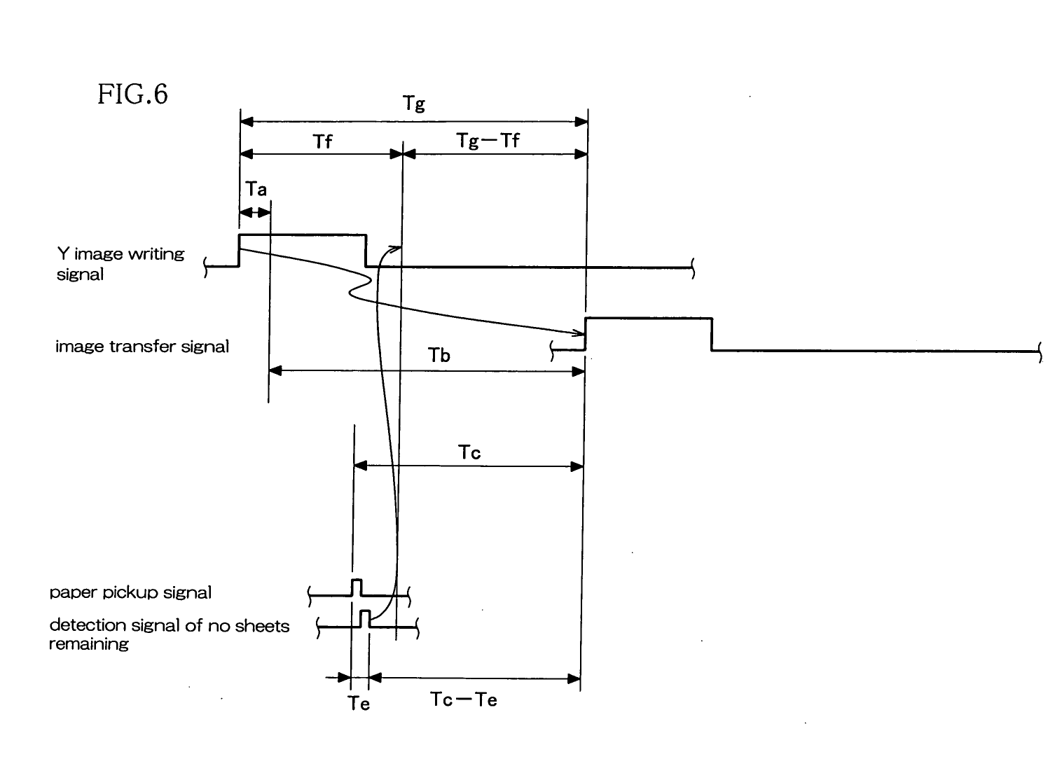

In the case of an image forming apparatus using a detection portion that detects there being no paper, as shown in FIG. 6, when the remaining stored number of sheets of paper P is detected by the detection portion 41 as zero sheets after the sheet of paper P has been picked up by the pickup roller 16, the output of the image writing signal relating to yellow stops. Furthermore, the same operation is also carried out with regard to the other colors (magenta, cyan, and black). However, as shown in FIG. 6, compared to the output time of the image writing signal relating to yellow, the time Th required from a point at which the writing process relating to yellow has finished until the toner adhering to the intermediate transfer belt 7 is transferred on the sheet of paper P by the secondary transfer roller 11 is long. For this reason, the transport time Tc from the pickup of the sheet of paper P by the pickup roller 16 until the transfer point of the sheet of paper P that has been picked up is required to be set long. That is, unlike the image forming apparatus 100 of working example 1, in the case of a image forming apparatus using a detection portion that detects there being no sheets of paper, a relationship of (Tc−Te)<(Tg−Tf) in regard to the detection target of the detection portion cannot be satisfied as shown in FIG. 6. As a result, a necessity arises to set longer the distance Sc of the transport path S shown in FIG. 4 of the sheet of paper P from the pickup roller 16 until the secondary transfer roller 11, and miniaturization of the image forming apparatus cannot be achieved. Furthermore, in a case where the distance Sc of the transport path indicated in working example 1 is employed in an image forming apparatus using a detection portion that detects there being no sheet of paper, when there is insufficient sheets of paper during successive printing and it is detected by the detection portion that there are no more sheets of paper P, a state occurs in which the image writing signals for the next sheet of paper P have been outputted and toner on the intermediate transfer belt 7 corresponding to the outputted signals is wasted. As a result, a burden is put on other components by wasted toner of the image forming system adhering to other components (the development unit 2, the photosensitive drum 3, and the cleaner unit 4). Thus, compared to working example 1, in an image forming apparatus using a detection portion that detects there being no sheet of paper, the distance Sc of the transport path S cannot be set shorter by shortening the transport time, and as a result, miniaturization of the image forming apparatus cannot be achieved. Furthermore, when the transport time is shortened to shorten the distance Sc of the transport path S, there is wasteful consumption of developer (toner) in the image forming system.

With the image forming apparatus 100 of the working example 1 described above, the detection portion 41 that detects the number of sheets of paper P stored in the paper supply cassette 10 is provided. When the image forming request number of sheets (print request number of sheets) to the sheets of paper P are for multiple sheets, the number of the sheets of paper P stored in the paper supply cassette 10 is detected by the detection portion 41 for being not more than a preset number of sheets (which is one sheet in this working example) but excluding zero sheets, such that the image writing sequence of the image forming system is changed in response to the detection with the detection portion 41 in order to avoid development by toner, and therefore unnecessary consumption of toner (wasted image writing) by the image forming system in the image forming apparatus 100 using the intermediate transfer system can be prevented. As a result, the burden on other components of the image forming system (such as the development unit 2, the photosensitive drum 3, and the cleaner unit 4) can be reduced, and the life of the image forming apparatus 100 can be increased. Specifically, when the print request number of sheets is for multiple sheets, the number of sheets of paper P stored in the paper supply cassette 10 is detected and image writing exceeding the number of sheets of paper P stored in the paper supply cassette 10 can be prevented.

Furthermore, once the sheet of paper P is transported from the paper supply cassette 10 to the image forming system, the image writing sequence for the transported sheet of paper P starts prior to the detection portion 41 detecting change in amount of paper remaining in the paper supply cassette 10, and therefore the start of the image writing sequence can be made earlier than the transport start timing of the sheet of paper P from the paper supply cassette 10 to the image forming system. As a result, the transport time for transporting the sheet of paper P from the paper supply cassette 10 to the image forming system can be shortened.

Furthermore, the paper detection target of the detection portion 41 is the remaining number of sheets (near-end number of sheets), and therefore compared to the detection unit that detects for no sheets as shown in FIG. 6, the transport time for transporting the sheet of paper P from the paper supply cassette 10 to the image forming system can be shortened with respect to the time from the completion of the image writing process relating to an arbitrary color until the actual transfer of the image onto the sheet of paper P (a part of image forming) as shown in FIG. 5. That is, the remaining number of sheets of paper P can be used effectively, and therefore the transport time for transporting the sheet of paper P from the paper supply cassette 10 to the image forming system can be shortened even in a case where the image writing for carrying out image forming onto the sheet of paper P in the image forming system is carried out before the sheet of paper P stored in the paper supply cassette 10 is transported to the image forming system, and as a result the transport distance of the sheet of paper P from the paper supply cassette 10 to the image forming system can be shortened as shown in FIG. 4, such that miniaturization of the image forming apparatus 100 can be achieved.

Specifically, as shown in FIGS. 4 to 6, in comparing working example 1 in which the detection portion 41 is used and an image forming apparatus using a detection portion that detects there being no sheet of paper, in the present working example the number of sheets of paper P stored in the paper supply cassette 10 is detected by the detection portion 41 for being not more than a preset number of sheets (which is one sheet in this working example) but excluding zero sheets, and therefore the distance Sb that the transfer position of the intermediate transfer belt 7 on which toner relating to yellow has been transferred moves to the secondary transfer roller 11 can be set longer with respect to the distance Sc of the transport path of the paper from the pickup roller 16 to the secondary transfer roller 11, and therefore miniaturization of the image forming apparatus 100 can be achieved. In particular, the present working example 1 is preferable for achieving miniaturization of the image forming apparatus 100 that uses the intermediate transfer system in which a color image is formed on the sheet of paper P by providing a plurality of image stations and performing en bloc transfer to the sheet of paper P.

Furthermore, for changes in the image writing sequence, the image writing operation in the image forming system is changed from image writing in-process to image writing stoppage, and therefore image writing can be stopped reliably.

Furthermore, the preset number of sheets, which is a condition of changing the image writing sequence, is a near-end number of sheets for the sheets of paper P being stored (which is from one sheet to several sheets), and in the present working example this is one sheet, but there is no limitation to this. And since the preset number of sheets of paper P is a near-end number of sheets, the sheet of paper P for which image writing has already been carried out and requires image forming after the change in the image writing sequence can be secured. As a result, all the sheets of paper P stored in the paper supply cassette 10 can be used at a time after there has been a change in the image writing sequence and image forming on the sheet of paper P by the image forming system has finished. That is, unnecessary consumption of toner in the image forming system (image writing to no purpose) can be prevented.

Furthermore, the detection portion 41 uses a double-feeding sensor that uses ultrasonic waves and therefore when the remaining stored number of sheets of paper P is a near-end number of sheets (from one sheet to several sheets), the number of sheets can be detected quickly and with excellent accuracy. Furthermore, an ultrasonic wave system sensor is used as the detection sensor and therefore in comparison to a sensor of a contact-type actuator system such as a lever, it is possible to carry out non-contact detection such that damage to the item targeted for detection (the sheets of paper P) during detection can be suppressed. Furthermore, in comparison to a laser system sensor, detection of the sheets of paper P can be carried out without affecting the color of the sheets of paper P.

Furthermore, the transmitter 42 and the receiver 43 are provided in the detection portion 41 and the paper supply cassette 10 is arranged between the transmitter 42 and the receiver 43, such that the ultrasonic waves transmitted from the transmitter 42 are incident at an angle on the sheets of paper P stored in the paper supply cassette 10 and received by the receiver 43 through the sheets of paper P, and therefore it is possible to prevent the ultrasonic waves that are incident on the sheets of paper P from being reflected back onto the transmitter 42.

Furthermore, the detection portion 41 has as a target for detection a transport direction trailing edge portion P1 of the sheets of paper P stored in the paper supply cassette 10, and therefore it is possible to confirm at an earliest point that the sheet of paper P has been transported (the number of sheets of paper P has decreased) when transport of the sheets of paper P stored in the paper supply cassette 10 has been carried out.

Furthermore, the relationship of (Tc−Te)<(Tg−Tf) is satisfied with respect to the target of detection for the detection portion 41, and therefore the transport time of transporting the sheets of paper P from the paper supply cassette 10 to the image forming system can be shortened.

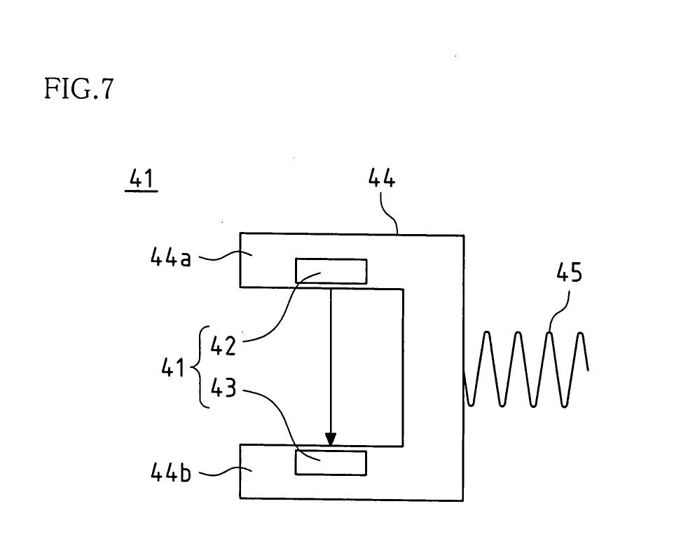

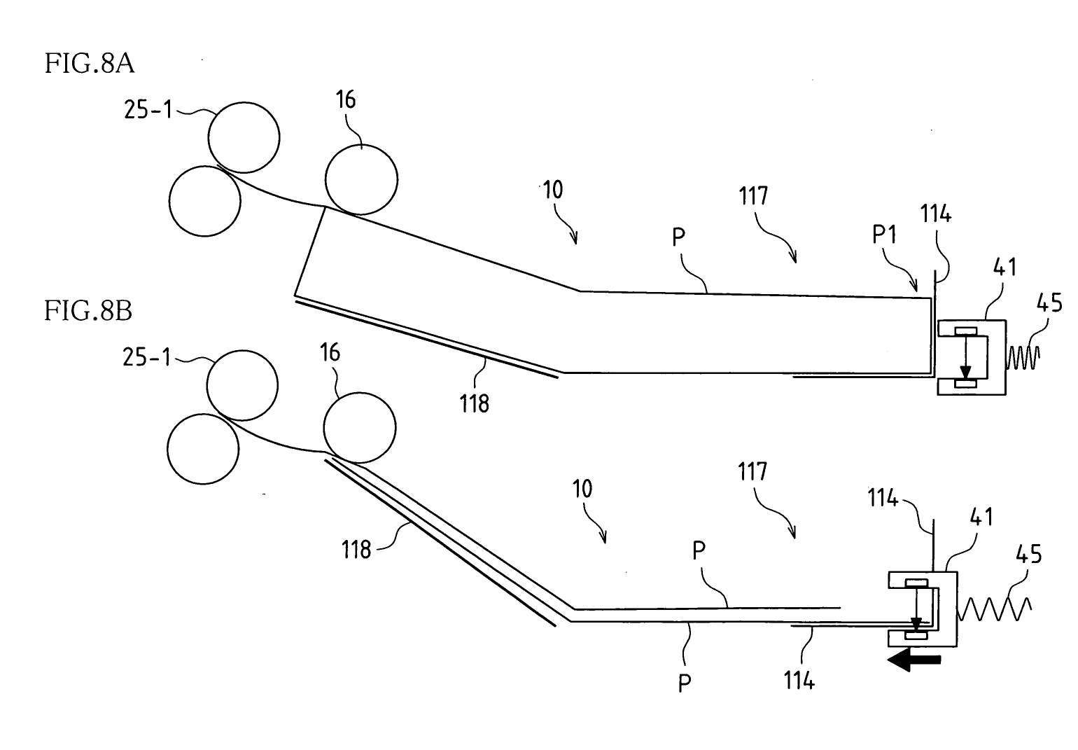

It should be noted that in the present working example 1, the detection portion 41 is provided in the paper trailing edge pressing plate 114 as shown in FIG. 2, but there is no limitation to this and the detection portion 41 need not be provided at the paper trailing edge pressing plate 114 if the detection target is set as the transport direction trailing edge portion P1 of the sheets of paper P stored in the paper supply cassette 10. Specifically, as shown in FIG. 7 and FIG. 8 (FIGS. 8A and 8B), the detection portion 41 may be a movable detection portion arranged near the transport direction trailing edge portion P1 of the sheets of paper P stored in the paper supply cassette 10. This movable type detection portion 41 is arranged so as to readily move in and out with respect to a paper storage region 117 in which the sheets of paper P are stored in the paper supply cassette 10. Furthermore, the detection portion 41 shown in FIGS. 7 and 8 is constituted by a main chassis 44 formed having a reverse, sharp cornered C shape in profile and is subjected to a biasing force toward the paper supply cassette 10 (the direction of the arrow in FIG. 8B) by an elastic structure 45 such as a spring, which is arranged behind the transport direction trailing edge portion P1 of the sheets of paper P in the paper supply cassette 10. Furthermore, the transmitter 42 is provided at an upper extending piece 44a of the main chassis 44, which is formed having a reverse, sharp cornered C shape in profile, and the receiver 43 is provided at a lower extending piece 44b of the main chassis 44, which is formed having a reverse, sharp cornered C shape in profile, and the positional relationship of the transmitter 42 and the receiver 43 is such that these are arranged in a vertical direction as viewed laterally and arranged in different positions as viewed from the top. Thus, the ultrasonic waves transmitted from the transmitter 42 are incident at an angle onto the sheets of paper P stored in the paper supply cassette 10 and received by the receiver 43 through the sheets of paper P.

Of the inward and outward movements of the detection portion 41 toward the paper storage region 117 shown in FIGS. 7 and 8, the inward movement of the detection portion 41 toward the paper storage region 117 is carried out using the biasing force of the elastic structure 45 when the stored number of sheets of paper P is not more than the preset number of sheets, and when the stored number of sheets of paper P exceeds the preset number of sheets, movement of the detection portion 41 is blocked by the sheets of paper P and the detection portion 41 cannot move into the paper storage region 117. It should be noted that the preset number of sheets referred to in this example is several tens of sheets for example and may be set based on a transceiving distance of the ultrasonic waves between the transmitter 42 and the receiver 43. Furthermore, a spring is employed in the elastic structure 45 shown in FIG. 8, but there is no limitation to this and other forms may be used as long as the detection portion 41 is subjected to a biasing force in a direction toward the paper supply cassette 10 (the arrow direction in FIG. 8B).

Compared to the detection portion 41 shown in FIG. 2, with the detection portion 41 shown in FIGS. 7 and 8, the distance between the sheets of paper P and the detection portion 41 is reduced and the detection accuracy can be improved. Furthermore, it is preferable when using a double-feeding sensor that uses ultrasonic waves for the detection portion 41. Furthermore, the detection portion 41 is not positioned in the paper storage region 117 when a greater number of sheets than the preset number of sheets are stored in the paper supply cassette 10 and therefore this can be kept from becoming an obstacle when paper is stored into the paper supply cassette 10, and the detection portion 41 is positioned in the paper storage region 117 when the number of sheets of paper P stored in the paper supply cassette 10 becomes not more than the preset number of sheets and therefore only at a time of this condition is the distance between the sheets of paper P and the detection portion 41 reduced to enable improvements in detection accuracy.

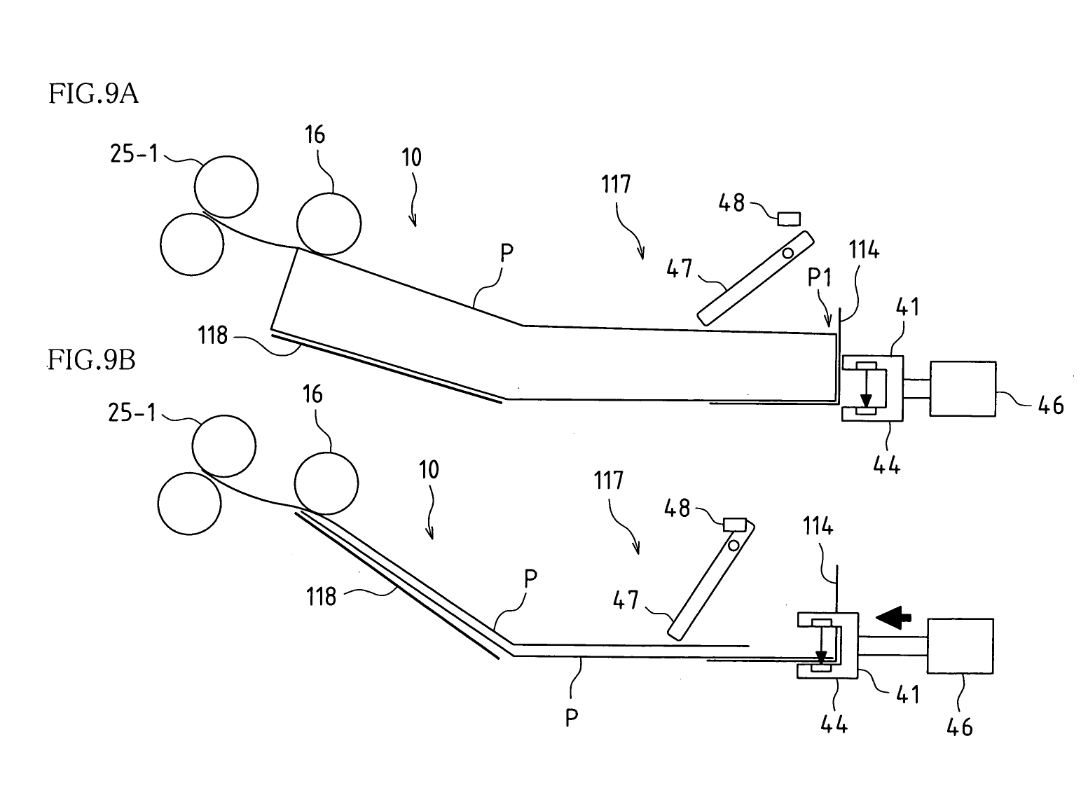

Furthermore, the elastic structure 45 is used in the detection portion 41 shown in FIGS. 7 and 8, but other forms are possible as long as the detection portion 41 can be moved in a direction toward the paper supply cassette 10 (the arrow direction in FIG. 8B), specifically, a form shown in FIG. 9 (FIGS. 9A and 9B) may be used.

The detection portion 41 shown in FIG. 9 is provided with the main chassis 44 formed having a reverse, sharp cornered C shape in profile shown in FIGS. 7 and 8, a solenoid portion 46 arranged at the main chassis 44, a detection lever portion 47 for detecting the sheets of paper P by contacting an upper surface of the sheets of paper P stored in the paper storage region 117, and a photo interrupter portion 48 that detects the stored number of sheets of paper P according to an angle of the detection lever portion 47 tilted by contact with the sheets of paper and causes the solenoid portion 46 to be driven.

The detection lever portion 47 is provided above the paper storage region 117, is constituted in a rod form so as to rotate freely centered on a predetermined axis, and one end thereof directly contacts the upper surface of the sheets of paper P stored in the paper storage region 117 and another end thereof passes between light receiving and emitting portions (see below) of the photo interrupter portion 48 due to change in a height of the sheets of paper P stored in the paper storage region 117.

The photo interrupter portion 48 is provided having light receiving and emitting portions (omitted from drawings) in opposition to each other, and detects the stored number of sheets of paper P stored in the paper storage region 117 using change in the insertion angle of the detection lever that inserts between the light receiving and emitting portions.

As shown in FIG. 9, the detection portion 41 detects the angle of the detection lever portion 47 using the light receiving and emitting portions of the photo interrupter portion 48, thereby detecting the stored number of sheets of paper P is not more than the preset number of sheets, and causing the solenoid portion 46 to be driven based on the detection of the photo interrupter portion 48 such that the main chassis 44 is caused to move as shown in FIG. 9 in a direction toward the paper supply cassette 10 (the arrow direction in FIG. 9B). Compared to the detection portion 41 shown in FIGS. 7 and 8, with the detection portion 41 shown in FIG. 9, there is no pressing contact of the main chassis 44 onto the sheets of paper P stored in the paper supply cassette 10 and it is possible to suppress abrasions to the sheets of paper P. That is, when the number of sheets of paper P stored in the paper supply cassette 10 becomes not more than the preset number of sheets and the detection portion 41 (the main chassis 44) moves in and out with respect to the paper storage region 117 when the detection portion 41 is arranged in the paper storage region 117, there is no contact of the detection portion 41 (the main chassis 44) to the sheets of paper P and it is possible to suppress abrasions to the sheets of paper P.

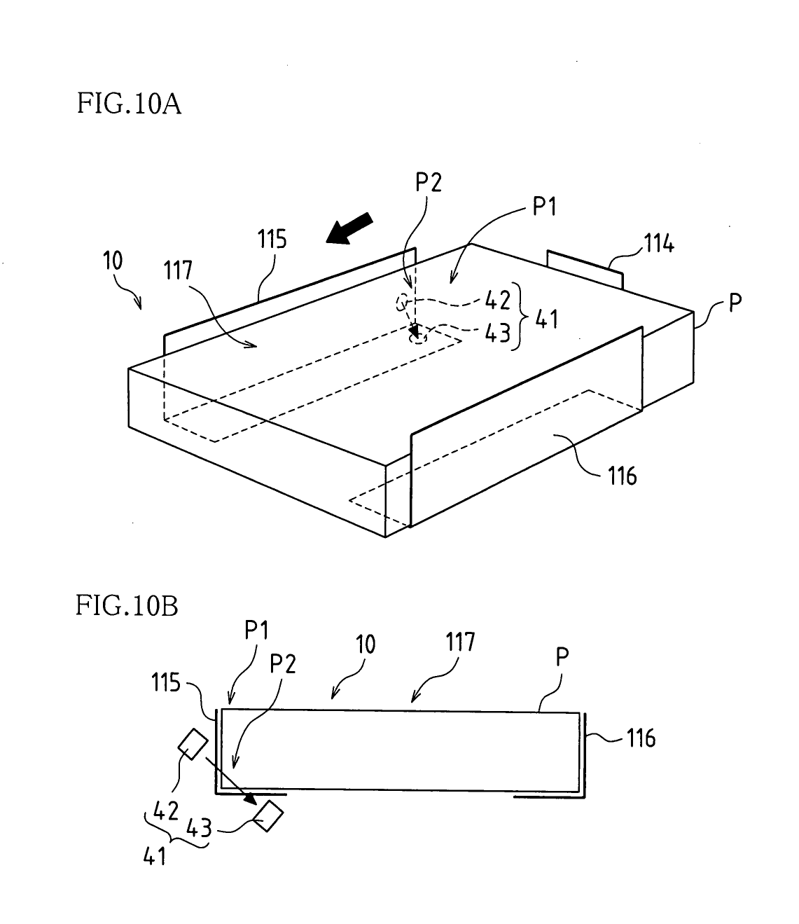

Furthermore, in the present working example 1, the detection portion 41 is provided in the paper trailing edge pressing plate 114 as shown in FIG. 2, but there is no limitation to this and the detection portion 41 may be provided in an arbitrary position as long as the detection target is set as the transport direction trailing edge portion P1 of the sheets of paper P stored in the paper supply cassette 10. Specifically, the detection portion 41 may be provided in a position indicated in FIG. 10 (FIG. 10A and FIG. 10B). The paper supply cassette 10 shown in FIG. 10 is provided with the paper trailing edge pressing plate 114 that regulates the transport direction trailing edge portion P1 of the sheets of paper P and a pair of width guides 115 and 116 that regulate the width direction of the sheets of paper P. Then, the detection portion 41 has as a target for detection a one side portion P2 of the sheets of paper P stored in the paper supply cassette 10 and the detection portion 41 is provided in the width guide 115, which is arranged along the transport direction of the sheets of paper P stored in the paper supply cassette 10 (the arrow direction shown in FIG. 10A). In detail, the detection portion 41 is provided at the transport direction trailing edge side of the sheets of paper P stored in the paper supply cassette 10 of the width guide 115 as shown in FIG. 10, and the transmitter 42 is provided in a position of a lateral surface side of the sheets of paper P of the width guide 115 and the receiver 43 is provided in a position of an under surface side of the sheets of paper P of the width guide 115. Then, the ultrasonic waves transmitted from the transmitter 42 are incident at an angle onto the sheets of paper P stored in the paper supply cassette 10 and received by the receiver 43 through the sheets of paper P.

Compared to the detection portion 41 shown in FIG. 2, with the detection portion 41 shown in FIG. 10, the sheets of paper P are stored having their width direction as a primary reference and their transport direction trailing edge side surface as a secondary reference, which enables unevenness in the storage of the sheets of paper P to be suppressed and enables paper transport errors originating in such storage unevenness to be prevented.

Also, the detection portion 41 shown in FIG. 10 has as its detection target the one side portion P2 of the sheets of paper P stored in the paper supply cassette 10, but there is no limitation to this and a detection portion 41 may also be provided in the width guide 116 such that both side portions of the sheets of paper P are detection targets, which enables the detection accuracy of the sheets of paper P to be improved. Furthermore, implemented combined use with the detection portion 41 shown in FIG. 4 or the detection portion 41 shown in 8 also enables the detection accuracy to be improved.

Furthermore, the detection portion 41 in the working example 1 detects that the number of sheets of paper P stored in the paper supply cassette 10 is one sheet such that in response to this detection the image writing operation of the image forming system is changed from image writing in-process to image writing stoppage, but there is no limitation to this, and other embodiments may be used as long as the image writing sequence of the image forming system is changed in order to prevent wasteful toner consumption by avoiding development using toner. For example, the changing of the image writing sequence may involve changing the voltage (the voltage relating to the development bias) applied to the development unit 2 (development roller) to an electric potential for toner adherence (applying a reverse polarity (+) electric potential if the toner charging polarity is (−)). Also, the positional relationship between the development unit 2 (development roller) and the photosensitive drum 3 may be configured such that the development roller and photosensitive drum 3 move apart from a state in which the development roller and the photosensitive drum 3 are in contact until a distance at which the electric potential of the photosensitive drum 3 does not physically affect the toner.

Furthermore, in the above-described detection portion 41, the transmitter 42 and the receiver 43 are arranged in a vertical direction having the surface of the sheets of paper P as the detection target but there is no limitation to this and the detection target may also be a thickness of the sheets of paper. In this case, a light sensor may be used as the detection portion 41.

Furthermore, as shown in FIG. 1, the present working example 1 was described concerning an example in which a single paper supply cassette 10 was provided in the image forming apparatus 100 as the paper supply portion, but application is also possible in cases where a plurality of paper supply cassettes are provided (see working example 2 below).

Furthermore, the detection portion 41 in working example 1 detects that the number of sheets of paper P stored in the paper supply cassette 10 is one sheet such that in response to this detection the image writing operation of the image forming system is changed immediately from image writing in-process to image writing stoppage, but there is no limitation to this, and in response to the detection the image writing operation of the image forming system may be changed from image writing in-process to image writing stoppage after a certain predetermined time as long as it is changed from image writing in-process to image writing stoppage (see working example 3 below).

### WORKING EXAMPLE 2

Next, description is given of an image forming apparatus according to a working example 2 using the accompanying drawings. It should be noted that the image forming apparatus according to working example 2 has a paper supply portion of a configuration different from working example 1 described above. Accordingly, description is given of working example 2 in regard to components different from working example 1 while description of equivalent components is omitted. For this reason, in regard to operational effects and modified examples of equivalent components, these have the same operational effects and modified examples as the above-described working example 1.

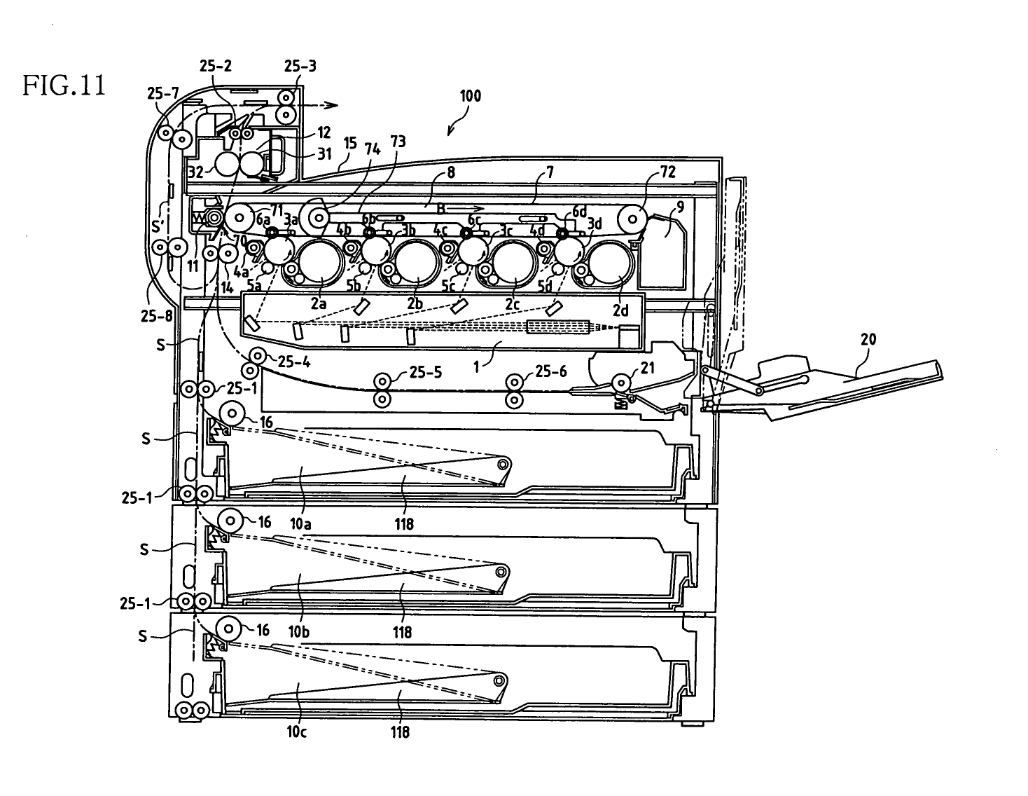

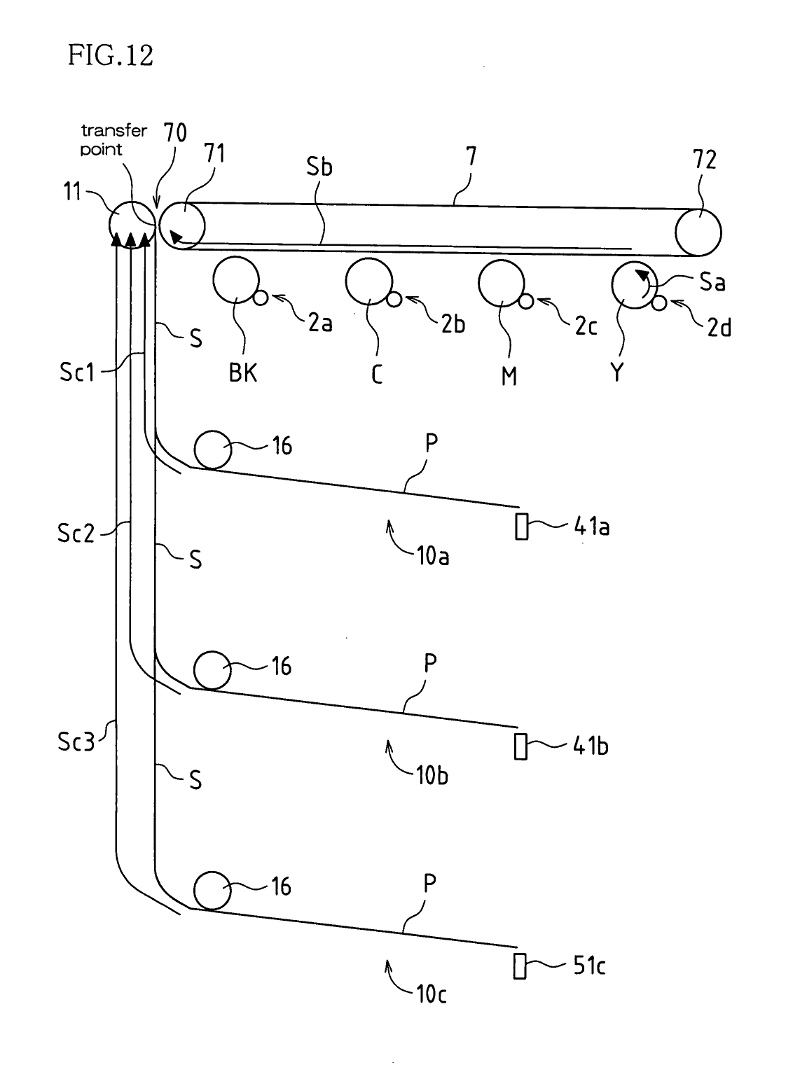

As shown in FIGS. 11 and 12, the paper supply portion of working example 2 is constituted by three paper supply cassettes 10a, 10b, and 10c. According to his/her use, a user can select any of the sheets of paper P supplied in the paper supply cassettes 10a, 10b, and 10c to use. It should be noted that the paper supply cassettes 10a, 10b, and 10c are constituted by an equivalent structure as the paper supply cassette 10 in working example 1. For this reason, description of the paper supply cassettes 10a, 10b, and 10c is omitted.

The transport times of the sheets of paper P transported from the paper supply cassettes 10a, 10b, and 10c to the image forming system (specifically, the secondary transfer portion 70) and transport distances (Sc1, Sc2, and Sc3) on the transport path S are set separately for the respective paper supply cassettes 10a, 10b, and 10c of working example 2. The transport distances Sc1, Sc2, and Sc3 on the transport path S are configured having a relationship of Sc1<Sc2<Sc3.

Then, with reference to FIG. 5, a double-feeding sensor that uses ultrasonic waves is used in the detection portion whose detection target is the paper supply cassette of the paper supply cassettes 10a, 10b, and 10c in which the relationship of symbols (Tc−Te)<(Tg−Tf) is satisfied. In working example 2, double-feeding sensors that use ultrasonic waves are used in detection portions 41a and 41b, whose detection targets are the paper supply cassettes 10a and 10b, an optical sensor or a contact type actuator such as a lever is used in a detection portion 51c, whose detection target is the paper supply cassette 10c.

The detection portion 41a whose detection target is the paper supply cassette 10a is a component that detects whether or not the number of sheets of paper P stored in the paper supply cassette 10a is not more than a near-end number of sheets (which is two sheets in this working example).

Furthermore, the detection portion 41b whose detection target is the paper supply cassette 10b is a component that detects whether or not the number of sheets of paper P stored in the paper supply cassette 10b is not more than a near-end number of sheets (which is one sheet in this working example).

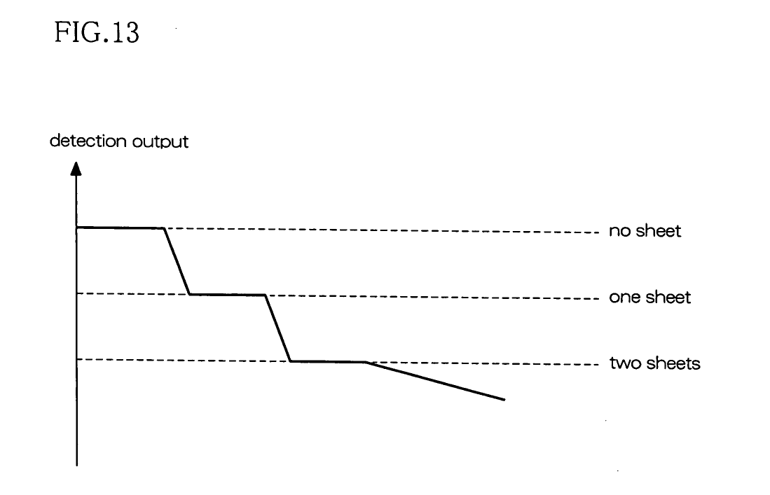

With the detection portions 41a and 41b, double feeding is determined based on an amount of attenuation of signals of the ultrasonic waves that are transmitted by the transmitter 42 and received by the receiver 43. It should be noted that FIG. 13 shows an amount of attenuation of signals of the ultrasonic waves when it is detected that there are no sheets, an amount of attenuation of signals of the ultrasonic waves when one sheet of paper is detected, and an amount of attenuation of signals of the ultrasonic waves when two sheets of paper are detected.

As described above, with working example 2, not only are there the operational effects of the image forming apparatus according to working example 1, but even when the paper supply cassettes 10a, 10b, and 10c are used, optimal paper detection can be carried out corresponding to all of the paper supply cassettes 10a, 10b, and 10c by the detection portions 41a, 41b, and 51c.

### WORKING EXAMPLE 3

Next, description is given of an image forming apparatus according to a working example 3 using the accompanying drawings. It should be noted that the image forming apparatus according to working example 3 has an image writing sequence change timing different from working example 1 described above. In particular, working example 3 has a configuration relating to switching of multicolor (color) and single color (monochrome) image forming for sheets of paper P stored in the same paper supply cassette 10. Accordingly, description is given of working example 3 in regard to components different from working example 1 while description of equivalent components is omitted. For this reason, in regard to operational effects and modified examples of equivalent components, these have the same operational effects and modified examples as the above-described working example 1. Furthermore, in regard to the above-described working example 2 also, only the components of the paper supply portion are different, and other components are the same components. For this reason, in regard to operational effects and modified examples of equivalent components, these have the same operational effects and modified examples as the above-described working example 2.

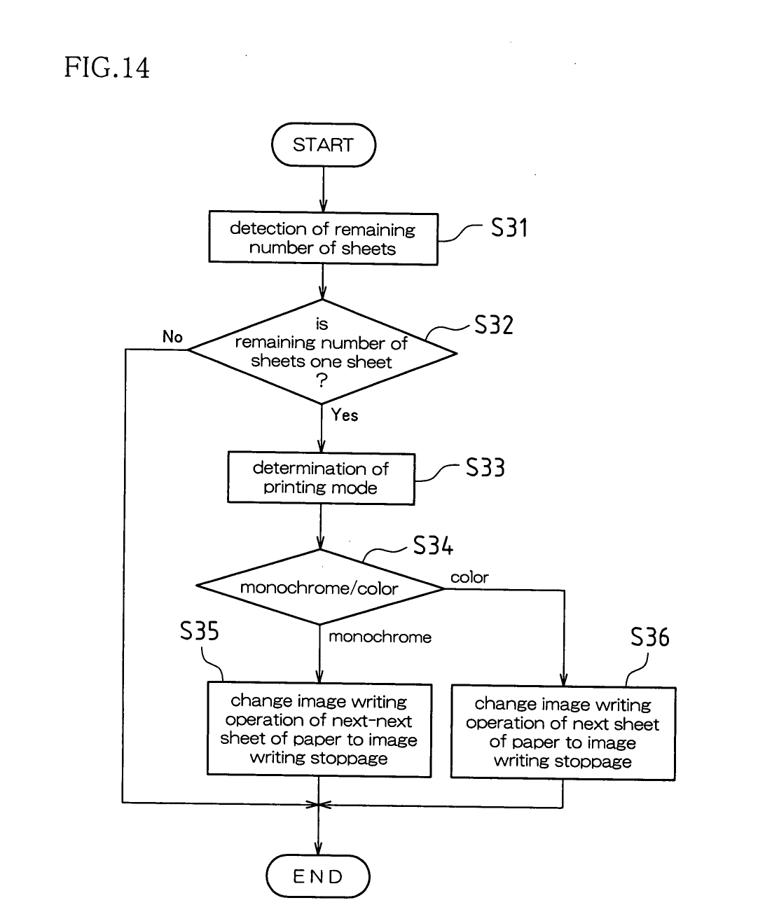

As shown in FIGS. 14 to 16, working example 3 involves carrying out image forming by selecting a printing mode of either a multicolor (color)/single color (monochrome) printing mode for the sheets of paper P stored in the paper supply cassette 10, a plurality of image forming portions (with symbols a, b, c, and d corresponding to the colors K, C, M, and Y) are provided in the image forming system, and the image forming portion or portions to be used is selected depending on the specified printing mode (color printing mode/monochrome printing mode), and changes in the image writing sequence are carried out depending on the printing mode. Specifically, in working example 3, when the printing mode is color printing mode, changes in the image writing sequence involve changing the image writing operation in the image forming system from image writing in-process to image writing stoppage, and when the printing mode is monochrome printing mode, changes in the image writing sequence involve changing the image writing operation in the image forming system to image writing stoppage after image writing of a preset number of sheets excluding zero sheets detected by the detection portion 41 has been carried out. That is, in working example 3, in the case of color printing mode, the image writing operation in the image forming system is changed immediately from image writing in-process to image writing stoppage, and in the case of monochrome printing mode, the image writing operation of the image forming system is changed from image writing in-process to image writing stoppage after a certain set time.

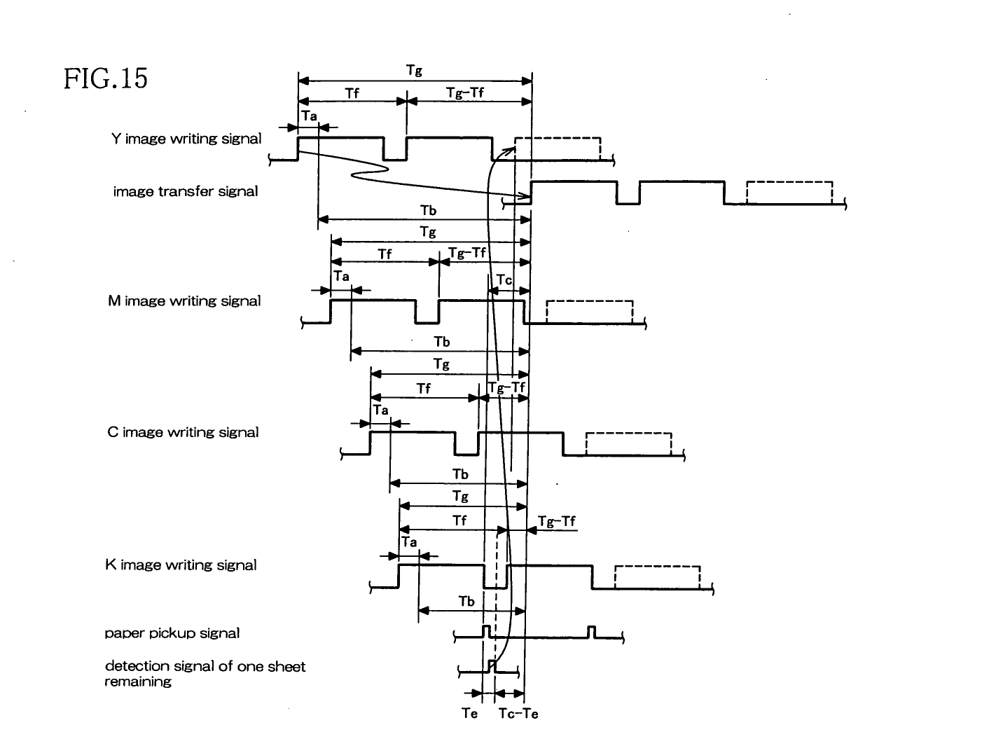

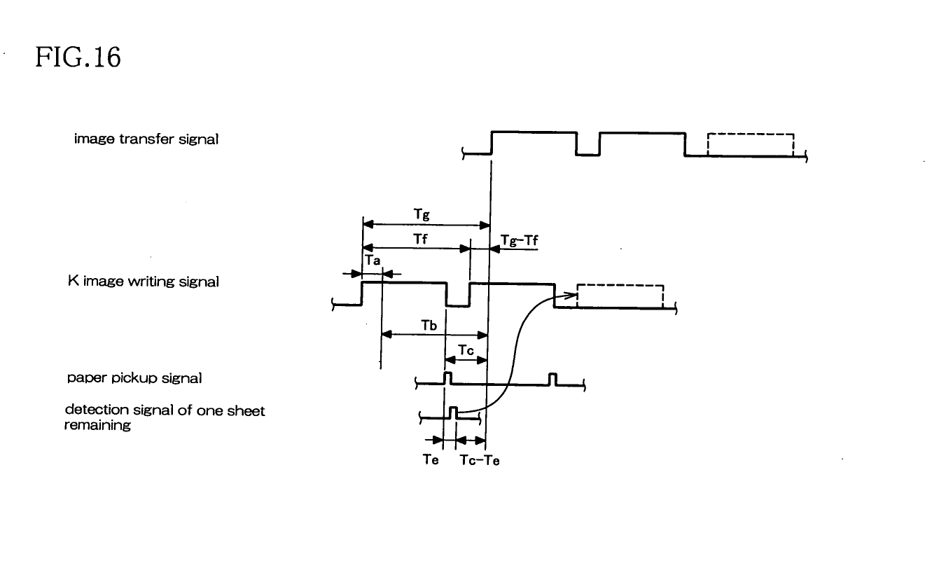

Description is given concerning image forming in the image forming apparatus 100 according to working example 3 using FIGS. 14 to 16. It should be noted that FIG. 14 is a flowchart relating to image forming in color printing mode and monochrome printing mode, FIG. 15 is a timing chart relating to image forming in color printing mode, and FIG. 16 is a timing chart relating to image forming in monochrome printing mode. Thus, unlike FIG. 5 in which there is only the signal relating to yellow (Y), FIG. 15 is a timing chart of signals relating to the other colors of magenta (M), cyan (C), and black (K). Specifically, the timing chart for color printing mode shown in FIG. 15 shows relationships between a Y image writing signal, an M image writing signal, a C image writing signal, a K image writing signal, an image transfer signal in the secondary transfer portion 70, a paper pickup signal of the pickup roller 16, and a detection signal of one sheet remaining being detected by the detection portion 41. Furthermore, the timing chart for monochrome printing mode shown in FIG. 16 shows relationships between the K image writing signal, an image transfer signal in the secondary transfer portion 70, a paper pickup signal of the pickup roller 16, and a detection signal of one sheet remaining being detected by the detection portion 41. Also, in FIGS. 15 and 16, the image writing signals during image writing in a case where a change in the image writing sequence is not carried out and the image writing signals are not stopped are shown for reference using dashed lines. It should be noted that symbols shown in FIGS. 15 and 16 indicate the same content as the symbols shown in FIG. 5 and description thereof is omitted here.

In the image forming apparatus 100 according to working example 3, by carrying out the paper supply process and the print processing of the sheets of paper P for the print request for multiple sheets, multiple printed sheets of paper P are discharged to the discharge tray 15 and the number of sheets of paper P stored in the paper supply cassette 10 continues to decrease. Here, as shown in FIG. 14, in the paper supply cassette 10, the remaining number of sheets of paper P stored in the paper supply cassette 10 is detected (step S31) by the detection portion 41. Then, detection is carried out (step S32) by the detection portion 41 as to whether the number of sheets of paper P stored in the paper supply cassette 10 is one sheet.

When it is detected in step S32 that the remaining number of sheets of paper P stored in the paper supply cassette 10 is two sheets or more (No at step S32), the image writing operation continues.

When it is detected in step S32 that the remaining number of sheets of paper P stored in the paper supply cassette 10 is one sheet (Yes at step S32), a determination is carried out (step S33) as to the printing mode of the print page (color printing mode or monochrome printing mode).

When the determination of printing mode is determined at step S33 and the printing mode is monochrome printing mode (“monochrome” at step S34), then as shown in FIGS. 14 and 16, the image writing operation is changed (step S35) from image writing in-process to image writing stoppage such that image writing is carried out to the next sheet of paper P (the remaining one sheet of paper P) after the sheet of paper P currently undergoing image forming, and image writing is stopped to the next-next sheet of paper P stored in the paper storage region 117 (which in fact is a sheet of paper P not being stored) and scheduled to be picked up next-next by the pickup roller 16, and image writing stops. It should be noted that as shown in FIG. 16, image writing is carried out onto the next sheet of paper P (the remaining one sheet of paper P). Furthermore, the next-next sheet of paper P at step S35 refers to a sheet of paper P not being stored in fact since the remaining number of sheets is one sheet.

When the determination of printing mode is carried out at step S34 and the printing mode is color printing mode (“color” at step S34), then as shown in FIGS. 14 and 15, the image writing operation is changed (step S36) from image writing in-process to image writing stoppage such that image writing to the next sheet of paper P (which in fact is a sheet of paper P not being stored) after the sheet of paper P currently undergoing image writing (the remaining one sheet of paper P) is stopped, and image writing stops.

It should be noted that the processes described in the above-described flowchart relating to image forming in the image forming apparatus 100 shown in FIG. 14 are carried out for each execution of pick up by the pickup roller 16 with respect to a single paper supply cassette 10 as shown in working example 1. Thus, for a case of a plurality of paper supply cassettes 10a to 10c as shown in working example 2, the processes described in the flowchart shown in FIG. 14 are carried out for each execution of pick up by the pickup roller 16 with respect to each of the plurality of paper supply cassettes 10a to 10c.

As described above, a plurality of image forming portions (having symbols a, b, c, and d) are provided in the image forming system and the image forming portion or portions to be used is/are selected depending on a specified printing mode, and image writing sequence changes are carried out depending on the printing mode. Specifically, the printing modes are constituted by the color printing mode and the monochrome printing mode, and when the printing mode is color printing mode, changes in the image writing sequence involve changing the image writing operation in the image forming system from image writing in-process to image writing stoppage, and when the printing mode is monochrome printing mode, changes in the image writing sequence involve changing the image writing operation in the image forming system to image writing stoppage after image writing of the one remaining sheet detected by the detection portion 41 has been carried out, and therefore it is possible to achieve not only the operational effects relating to working example 3 of the above-described working examples 1 and 2, but also to selectively determine an optimal image forming portion based on the printing mode set arbitrarily by the user and to execute an optimal image writing sequence in which wasteful image writing is eliminated. For this reason, it is possible to prevent unnecessary consumption (image writing to no purpose) of developer (toner) in the image forming system of the image forming apparatus using the intermediate transfer system.

It should be noted that in working example 3 color printing mode/monochrome printing mode are given as the printing modes, but there is no limitation to this. The printing modes may be constituted by an n color printing mode and an m color printing mode having more colors than n colors, and when the printing mode is the m color printing mode, changes in the image writing sequence may involve changing the image writing operation in the image forming system from image writing in-process to image writing stoppage, and when the printing mode is the n color printing mode, changes in the image writing sequence may involve changing the image writing operation in the image forming system to image writing stoppage after image writing of a preset number of sheets (for example, one sheet to several sheets) excluding zero sheets detected by the detection portion 41 has been carried out.

### WORKING EXAMPLE 4

Next, description is given of an image forming apparatus according to a working example 4 using the accompanying drawings. It should be noted that the image forming apparatus according to working example 4 is a modified example of the above-described working example 3 and has printing mode settings different from working example 3 described above. For this reason, components other than the different components have the same operational effects and modified examples as working example 3. Accordingly, description is given of working example 4 in regard to components different from working example 3 while description of equivalent components is omitted.

As in the above-described working examples, the intermediate transfer system according to working example 4 is a system in which image writing is carried out in a plurality of image forming portions (with symbols a, b, c, and d corresponding to the colors K, C, M, and Y) respectively, and respective images from the plurality of image forming portions (with symbols a, b, c, and d) are layered and transferred in a preset order then transferred en bloc to a sheet of paper.

Then, the intermediate transfer system is constituted by a late printing mode using, of the plurality of image forming portions (with symbols a, b, c, and d), an image forming portion that performs layer in an order later than a preset layer order including non-transfer image forming portions, and an early printing mode using, of the plurality of image forming portions (with symbols a, b, c, and d), an image forming portion that performs layer in an order earlier than the preset layer order including non-transfer image forming portions. In the present working example, the preset layer order is set to the image forming portion (the image forming portion (symbol b) shown in FIG. 1 that is third to superimpose) that superimposes C (cyan). Here, “non-transfer” refers to transfer not being carried out by image forming portions of colors not used in the image forming onto the sheet of paper P. It should be noted that in the present working example, regardless of whether or not transfer is carried out, the image forming portion first to superimpose is the Y image forming portion (symbol d), the image forming portion second to superimpose is the M image forming portion (symbol c), the image forming portion third to superimpose is the C image forming portion (symbol b), and the image forming portion fourth to superimpose is the K image forming portion (symbol a).

That is, the printing modes according to the present working example are constituted by the early printing mode, which includes at least one of Y (yellow) and M (magenta), and the late printing mode, which includes at least one of C (cyan) and K (black) without using either of Y (yellow) or M (magenta). It should be noted that naturally in the early printing mode it is also possible for only Y (yellow) and K (black) to be used according to arbitrary print settings of the user.

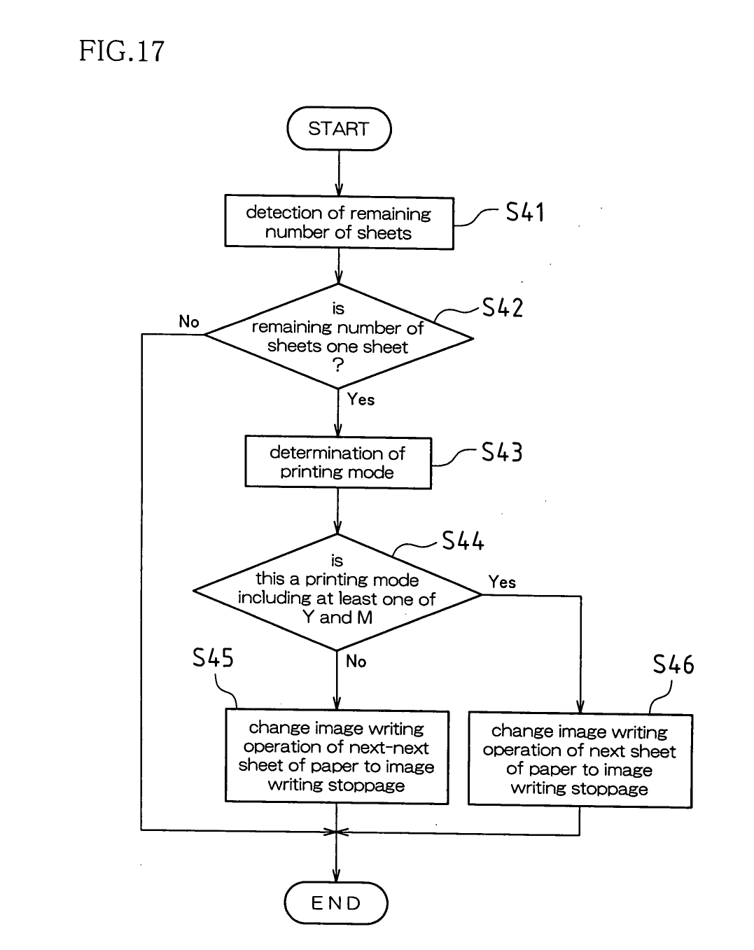

As shown in FIGS. 17 to 19, working example 4 involves carrying out image forming by selecting a printing mode of either the early printing mode or the late printing mode for the sheets of paper P stored in the paper supply cassette 10, a plurality of image forming portions (with symbols a, b, c, and d) are provided in the image forming system, and the image forming portion or portions to be used is/are selected depending on the specified printing mode (early printing mode/late printing mode), and changes in the image writing sequence are carried out depending on the printing mode. That is, when the printing mode is the early printing mode, changes in the image writing sequence involve changing the image writing operation in the image forming system from image writing in-process to image writing stoppage, and when the printing mode is the late printing mode, changes in the image writing sequence involve changing the image writing operation in the image forming system to image writing stoppage after image writing of a preset number of sheets (which is one sheet in the present working example) excluding zero sheets detected by the detection portion 41 has been carried out. That is, in working example 4, in the case of the early printing mode, the image writing operation in the image forming system is changed immediately from image writing in-process to image writing stoppage, and in the case of the late printing mode, the image writing operation of the image forming system is changed from image writing in-process to image writing stoppage after a certain set time.

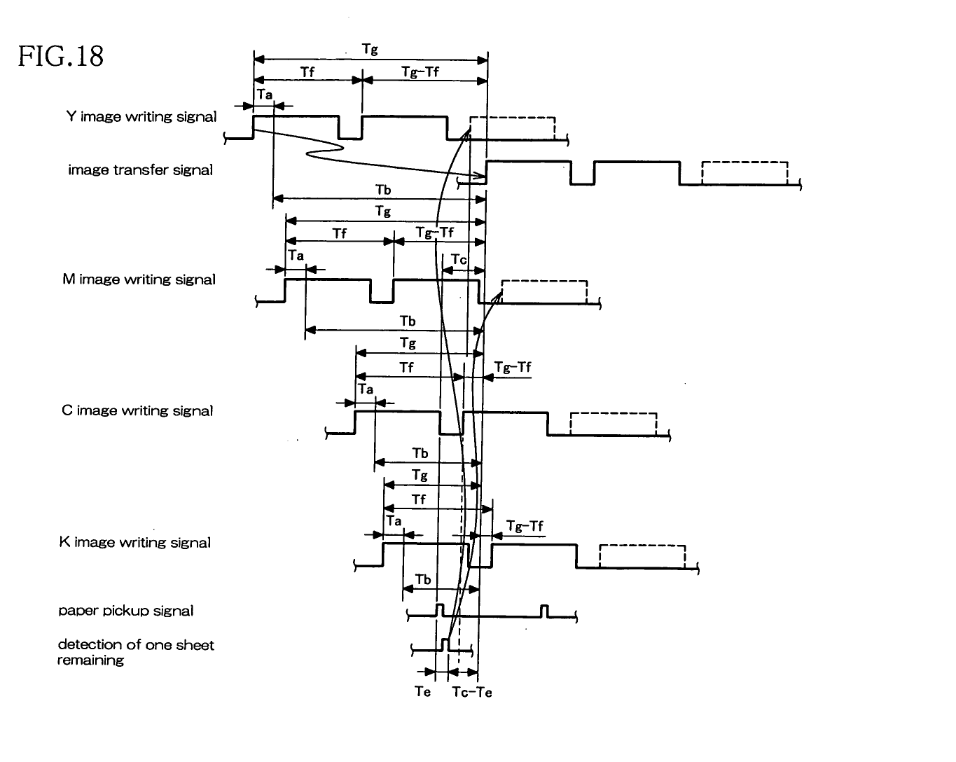

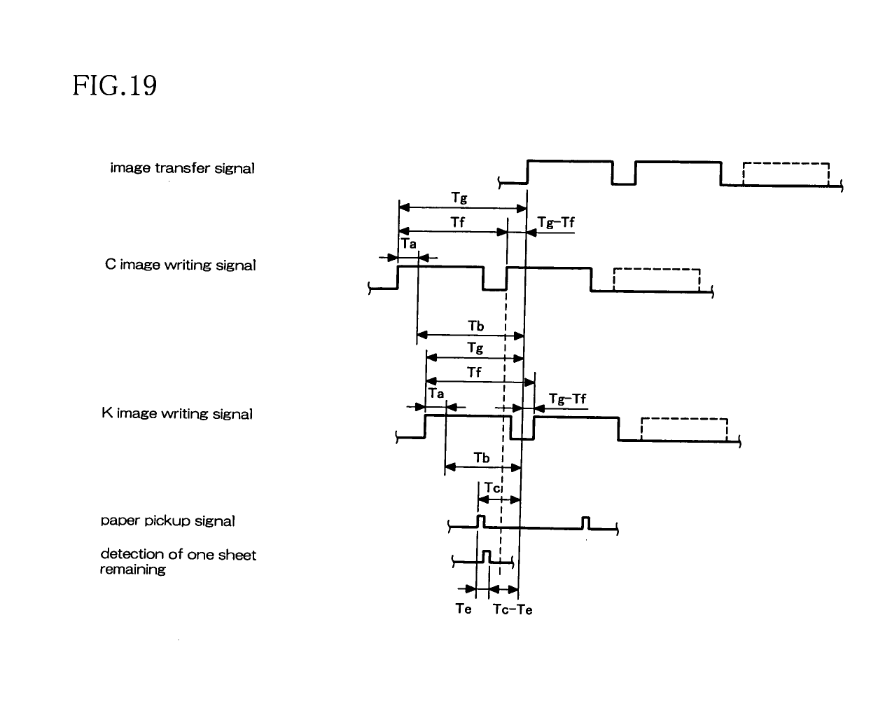

Description is given concerning image forming in the image forming apparatus 100 according to working example 4 using FIGS. 17 to 19. It should be noted that FIG. 17 is a flowchart relating to image forming in an early printing mode/late printing mode, FIG. 18 is a timing chart relating to image forming in the early printing mode, and FIG. 19 is a timing chart relating to image forming in the late printing mode. Thus, unlike FIG. 5 in which there is only the signal relating to yellow (Y), FIG. 18 is a timing chart of signals relating to the other colors of magenta (M), cyan (C), and black (K). Specifically, the timing chart for early printing mode shown in FIG. 18 shows relationships between a Y image writing signal, an M image writing signal, a C image writing signal, a K image writing signal, an image transfer signal in the secondary transfer portion 70, a paper pickup signal of the pickup roller 16, and a detection signal of one sheet remaining being detected by the detection portion 41. Furthermore, the timing chart for the late printing mode shown in FIG. 19 shows relationships between the C image writing signal, the K image writing signal, an image transfer signal in the secondary transfer portion 70, a paper pickup signal of the pickup roller 16, and a detection signal of one sheet remaining being detected by the detection portion 41. Also, in FIGS. 18 and 19, the image writing signals during image writing in a case where a change in the image writing sequence is not carried out and the image writing signals are not stopped are shown for reference using dashed lines. It should be noted that symbols shown in FIGS. 18 and 19 indicate the same content as the symbols shown in FIG. 5 and description thereof is omitted here.

In the image forming apparatus 100 according to the present working example 4, by carrying out the paper supply process and the print processing of the sheets of paper P for a print request for multiple sheets, multiple printed sheets of paper P are discharged to the discharge tray 15 and the number of sheets of paper P stored in the paper supply cassette 10 continues to decrease. Here, as shown in FIG. 17, in the paper supply cassette 10, the remaining number of sheets of paper P stored in the paper supply cassette 10 is detected (step S41) by the detection portion 41. Then, detection is carried out (step S42) by the detection portion 41 as to whether the number of sheets of paper P stored in the paper supply cassette 10 is one sheet.

When it is detected in step S42 that the remaining number of sheets of paper P stored in the paper supply cassette 10 is two sheets or more (No at step S42), the image writing operation continues.

When it is detected in step S42 that the remaining number of sheets of paper P stored in the paper supply cassette 10 is one sheet (Yes at step S42), a determination is carried out (step S43) as to the printing mode of the print page (early printing mode or late printing mode).

When the determination of printing mode is determined at step S43 and the printing mode is the late printing mode (No at step S44), then as shown in FIGS. 17 and 19, the image writing operation is changed (step S45) from image writing in-process to image writing stoppage such that image writing is carried out to the next sheet of paper P (the remaining one sheet of paper P) after the sheet of paper P currently undergoing image forming, and image writing is stopped to the next-next sheet of paper P stored in the paper storage region 117 (which in fact is a sheet of paper P not being stored) and scheduled to be picked up next-next by the pickup roller 16, and image writing stops. It should be noted that as shown in FIG. 19, image writing is carried out onto the next sheet of paper P (the remaining one sheet of paper P). Furthermore, the next-next sheet of paper P at step S45 refers to a sheet of paper P not being stored in fact since the remaining number of sheets is one sheet.

When the determination of printing mode is carried out at step S44 and the printing mode is the late printing mode (Yes at step S44), then as shown in FIGS. 17 and 18, the image writing operation is changed (step S46) from image writing in-process to image writing stoppage such that image writing to the next sheet of paper P (which in fact is a sheet of paper P not being stored) after the sheet of paper P currently undergoing image writing (the remaining one sheet of paper P) is stopped, and image writing stops.

It should be noted that the processes described in the above-described flowchart relating to image forming in the image forming apparatus 100 shown in FIG. 17 are carried out for each execution of pick up by the pickup roller 16 with respect to a single paper supply cassette 10 as shown in working example 1. Thus, for a case of a plurality of paper supply cassettes 10a to 10c as shown in working example 2, the processes described in the flowchart shown in FIG. 14 are carried out for each execution of pick up by the pickup roller 16 with respect to each of the plurality of paper supply cassettes 10a to 10c.

As described above, a plurality of image forming portions (having symbols a, b, c, and d) are provided in the image forming system and the image forming portion or portions to be used is/are selected depending on a specified printing mode, and image writing sequence changes are carried out depending on the printing mode. Specifically, the printing modes are constituted by a late printing mode using, of the plurality of image forming portions, an image forming portion that performs layer in an order later than a preset layer order (third to perform layer, which corresponds to C (cyan) in this case) including non-transfer image forming portions of the plurality of image forming portions, and an early printing mode using, of the plurality of image forming portions, an image forming portion that performs layer in an order earlier than the preset layer order (third to perform layer, which corresponds to C (cyan) in this case) including non-transfer image forming portions, and when the printing mode is the early printing mode, changes in the image writing sequence involve changing the image writing operation in the image forming system from image writing in-process to image writing stoppage, and when the printing mode is the late printing mode, changes in the image writing sequence involve changing the image writing operation in the image forming system to image writing stoppage after image writing of the one remaining sheet detected by the detection portion has been carried out, and therefore it is possible to achieve not only the operational effects relating to working example 4 of the above-described working examples 1 to 3, but also to selectively determine an optimal image forming portion based on the printing mode set arbitrarily by the user and to execute an optimal image writing sequence. For this reason, it is possible to prevent unnecessary consumption (image writing to no purpose) of developer (toner) in the image forming system of the image forming apparatus using the intermediate transfer system.

It should be noted that in the present working example 4, four colors (K, C, M, and Y) are used, and the subject color of the early printing mode is set to include at least one of Y and M, and the subject color of the late printing mode is set to C and K, but there is no limitation to this, and for example five colors may be used and the subject color of the early printing mode may be set to include at least three colors that are transferred first, and the subject color of the late printing mode may be set to two colors that are transferred last.

As described above, transport rollers and transport mechanisms according to the present invention can be applied in an image forming apparatus main unit provided with such functions as a copy function, a print function, and a facsimile function.

The present invention can be embodied and practiced in other different forms without departing from the purport and essential characteristics thereof. Therefore, the above-described examples are considered in all respects as illustrative and not restrictive. The scope of the invention is indicated by the appended claims rather than by the foregoing description. All variations and modifications falling within the equivalency range of the appended claims are intended to be embraced therein.

What is claimed is:

1. An image forming apparatus that comprises a paper supply portion that stores a sheet of paper on which image forming is carried out and an image forming system that carries out image forming on the sheet of paper transported from the paper supply portion, and that uses an intermediate transfer system in which image writing for carrying out image forming onto the sheet of paper is carried out in the image forming system before the sheet of paper stored in the paper supply portion is transported to the image forming system,
wherein a detection portion is provided that detects the number of sheets of paper stored in the paper supply portion,
as a result of the detection portion detecting that the number of sheets of paper stored in the paper supply portion is not more than a preset number of sheets excluding zero sheets, an image writing sequence in the image forming system is changed in response to the detection in order to avoid development by developer,
a plurality of image forming portions are provided in the image forming system and the image forming portion or portions to be used is/are selected depending on a specified printing mode, and
the change in the image writing sequence is carried out depending on the printing mode.

2. The image forming apparatus according to claim 1, wherein prior to detection of a change in an amount of paper remaining in the paper supply portion by the detection portion after the sheet of paper has been transported from the paper supply portion to the image forming system, an image writing sequence starts for the sheet of paper that has been transported.

3. The image forming apparatus according to claim 1, wherein the change in the image writing sequence involves changing an image writing operation in the image forming system from image writing in-process to image writing stoppage.

4. The image forming apparatus according to claim 1, wherein the preset number of sheets refers to the number of sheets of paper stored being a near-end number of sheets.

5. The image forming apparatus according to claim 4, wherein the detection portion uses an ultrasonic sensor.

6. The image forming apparatus according to claim 5, wherein
the detection portion is provided with a transmitter that transmits ultrasonic waves and a receiver that receives the ultrasonic waves transmitted from the transmitter,
the paper supply portion is arranged between the transmitter and the receiver, and
the ultrasonic waves transmitted from the transmitter are incident at an angle onto sheets of paper stored in the paper supply portion and received by the receiver through the sheets of paper.

7. The image forming apparatus according to claim 1, wherein the detection portion has as a detection target a transport direction trailing edge portion of a sheet of paper stored in the paper supply portion.

8. The image forming apparatus according to claim 1, wherein the detection portion has as a detection target at least a one side portion of a sheet of paper stored in the paper supply portion.

9. The image forming apparatus according to claim 1, wherein
the detection portion is a movable detection portion, and
the detection portion is arranged so as to readily move in and out with respect to a paper storage region in which a sheet of paper is stored in the paper supply portion.

10. The image forming apparatus according to claim 9, wherein a movement of the detection portion toward the paper storage region is carried out when the number of sheets of paper stored in the paper supply portion is not more than a preset number of sheets.

11. The image forming apparatus according to claim 10, wherein the detection portion is provided with a detection lever portion that contacts an upper surface of a sheet of paper and a photo interrupter portion that detects an angle at which the detection lever portion tilts due to contact with the sheet of paper.

12. The image forming apparatus according to claim 1, wherein
when a time from an image writing sequence start until a formed development image reaches a transfer point to a sheet of paper is given as Tg, a time from an image writing sequence start until a next image writing sequence start is given as Tf, a time from start of supply of a sheet of paper from the paper supply portion until the sheet of paper reaching the transfer point is given as Tc, and a time from start of supply of a sheet of paper from the paper supply portion until detection of a change in an amount of paper remaining by the detection portion is given as Te,
a relationship of (Tc−Te)<(Tg−Tf) is satisfied with respect to a detection target of the detection portion.

13. The image forming apparatus according to claim 12, wherein
a plurality of paper supply cassettes are included in the paper supply portion,
respective transport times of a sheet of paper transported from the paper supply cassettes to the image forming system are set separately for the plurality of paper supply cassettes, and
an ultrasonic sensor is used in the detection portion whose detection target is the paper supply portion satisfying the relationship of (Tc−Te)<(Tg−Tf).

14. The image forming apparatus according to claim 1, wherein
the printing modes are constituted by an n color printing mode and an m color printing mode having more colors than n colors,
when the printing mode is the m color printing mode, the change in the image writing sequence involves changing an image writing operation in the image forming system from image writing in-process to image writing stoppage, and
when the printing mode is the n color printing mode, the change in the image writing sequence involves changing the image writing operation in the image forming system to the image writing stoppage after image writing of the preset number of sheets excluding zero sheets detected by the detection portion has been carried out.

15. The image forming apparatus according to claim 14, wherein
the printing modes are constituted by a color printing mode and a monochrome color printing mode,
when the printing mode is the color printing mode, the change in the image writing sequence involves changing the image writing operation in the image forming system from the image writing in-process to the image writing stoppage, and
when the printing mode is the monochrome color printing mode, the change in the image writing sequence involves changing the image writing operation in the image forming system to the image writing stoppage after image writing of the preset number of sheets excluding zero sheets detected by the detection portion has been carried out.

16. The image forming apparatus according to claim 1, wherein
the intermediate transfer system is a system in which image writing is carried out in a plurality of image forming portions respectively, and respective images from the plurality of image forming portions are layered and transferred in a preset order, and then transferred en bloc to a sheet of paper,
constituted by a late printing mode using, of the plurality of image forming portions, an image forming portion that performs layer in an order later than a preset layer order including non-transfer image forming portions that do not perform transfer due to not being used in image forming onto the sheet of paper, and an early printing mode using, of the plurality of image forming portions, an image forming portion that performs layer in an order earlier than the preset layer order including non-transfer image forming portions that do not perform transfer due to not being used in image forming onto the sheet of paper,
when the printing mode is the early printing mode, the change in the image writing sequence involves changing an image writing operation in the image forming system from image writing in-process to image writing stoppage, and
when the printing mode is the late printing mode, the change in the image writing sequence involves changing the image writing operation in the image forming system to the image writing stoppage after image writing of the preset number of sheets excluding zero sheets detected by the detection portion has been carried out.
